(19) United States
(12) Patent Application Publication
(10) Pub. No.: US 2014/0149289 A1
(43) Pub. Date: May 29, 2014

(54) Method and Apparatus for the Restricted Transfer of Funds

(71) Applicant: George Cox Beighley, JR., Columbia, SC (US)

(72) Inventor: George Cox Beighley, JR., Columbia, SC (US)

(21) Appl. No.: 14/088,382

(22) Filed: Nov. 23, 2013

Related U.S. Application Data
(60) Provisional application No. 61/729,506, filed on Nov. 23, 2012.

(51) Int. Cl. G06Q 20/10; G06Q 20/40

(52) U.S. Cl. CPC G06Q 20/10; G06Q 20/40
USPC 705/44

(57) ABSTRACT

The following invention is a method and apparatus for the restricted transfer of funds that allows for users to set a transfer amount they are willing to transfer, place restrictions on the transfer of the funds through the insertion of a restriction identity or category, transfer the funds to a second bank account subject to the restrictions placed on the funds. This invention allows payor's to associate restrictions on future expenses such as which merchant, which category of item, or which specific item a payee is allowed to purchase. Further, a method for the creation of a secure digital check is disclosed and claimed.

### PRIORITY CLAIM

This application claims priority under 35 U.S.C. §119(e) from U.S. Provisional Patent Application 61/729,506 entitled “Method and Apparatus for the Restricted Transfer of Funds” filed on Nov. 23, 2012, which is hereby incorporated by reference in its entirety.

### SUMMARY OF INVENTION

There are several processes for a payor engaging in the restricted transfer of funds: online and offline. In the online method, a payor accesses a payor's bank site through the internet. The payor submits a payor's bank account identity, an amount for the restricted transfer and inputs the restrictions on to the banks website. The payor inputs the payee's bank account identity into payor's bank site (hereinafter bank 0). The restrictions are collected from an online database of restrictions stored by the Bank 0. A restriction database that defines a code associated with a merchant or category restriction has a common listing for all banking institutions. The bank then accesses a database connected to the banks system to determine the appropriate restriction code associated with the restricted transfer of funds. The bank then transfers the funds, the restriction code, and the payee bank account identity via a secure electronic funds transfer mechanism to the payee's bank (hereinafter Bank 1). Bank 1 receives the deposit of funds from Bank 0. Bank 1 then accesses the database to determine the restrictions associated with the restriction code. Bank 1 then stores those restrictions with the amount transferred and the payee's bank account identity on a database connected to Bank 1's system. Bank 1 then adds the restricted funds to the Payee's bank account. In an optional embodiment, the payor selects whether the restricted funds will be used first or after other funds have been depleted.

When the payee goes to spend the funds, the merchant sends bank 1 the merchant category or the product description or category associated with the purchase and the amount of the purchase. Bank 1 receives the information and first determines if unrestricted funds are to be spent first or the restricted funds are to be spent first. If the restricted funds are to be spent bank 1 compares the product category or merchant category with the approved category code. If the product category or merchant category matches the approved category code and there are sufficient funds then Bank 1 approves the expense. If the product category or merchant category is not approved then Bank 1 denies the expense.

In an alternative embodiment, the restricted funds are transferred to a separate account that exists until the funds are dispersed. The account can be at either the payor's bank, the payee's bank, or a third bank. Optionally, the payor selects when inputting the restrictions which bank will hold the separate account. In the embodiment where the payee's bank stores the separate account with restricted funds, the following happens upon the payee submitting to the merchant a request that the bank make payment. The merchant sends bank 1 the merchant category or the product description associated with the purchase and the amount of the purchase. Bank 1 receives the information and first determines if unrestricted funds are to be spent first or the restricted funds are to be spent first. If the restricted funds are to be spent bank 1 accesses the funds stored in the separate account and compares the product category or merchant category with the approved category code. If the product category or merchant category matches the approved category code and there are sufficient funds then Bank 1 approves the expense. If the product category or merchant category is not approved then Bank 1 denies the expense.

In the embodiment where the payor's bank or a third bank store the separate funds, upon the payee submitting to the merchant a request that the bank make payment the following happens. The merchant sends bank 1 the merchant category or the product description or category associated with the purchase and the amount of the purchase. Bank 1 receives the information and first determines if unrestricted funds are to be spent first or the restricted funds are to be spent first. If the restricted funds are to be spent bank 1 sends a request for funds, the amount of funds requested, and the category of the purchase or merchant to either the payor's bank or the third bank (wherever the separate account is stored). The payor's bank or the third bank accesses the funds stored in the separate account and compares the product category or merchant category with the approved category code. If the product category or merchant category matches the approved category code and there are sufficient funds then the payor's bank or third bank approves the expense. If the product category or merchant category is not approved then payor's bank or third bank denies the expense.

In the offline electronic method, a payor writes a payee a restricted check and gives the check to the payee. A restricted check is a check containing payor bank number, check security procedures, payee identity, amount, and restrictions. The payor writes the category or merchant restriction in a location contained on the check. In an optional embodiment, the payor accesses a restriction database online containing the restrictions codes associated with different categories or merchants. In this embodiment, the payor then writes the restriction code directly on the check.

One of two processes occurs next. First, the payee gives the check to a banking institution. The check is scanned by a scanning device, which creates a digital image of the check. The digital image is parsed to determine the check payee, the amount, the identity of the payor's account, and the restrictions. The restrictions are stored with the funds and the restricted funds are transferred to the payee's bank account.

Second, the payee scans the check with a scanning device creating a digital image of the check. The payee engages in an electronic transfer of the digital image to a bank. The digital image is parsed to determine the check payee, the amount, the identity of the payor's account, and the restrictions. The restrictions are stored with the funds and the restricted funds are transferred to the payee's bank account.

In an additional method, a payor writes a payee a secure digital check. The payor electronically creates a check in the form of a digital image by accessing the banks website. Optionally, the payor enters restrictions to the check. The payor saves the check as a digital image. The payor electronically sends the check to the payee via email or other form of electronic communication. The payee electronically or manually deposits the digital check. As shown in FIG. 12, the payor logs on to a banks website and selects the “Create Secure Digital Check” option 1201. The payor enters the payee, check amount and optionally the date. If the payor desires to add restrictions the payor clicks add restrictions. If the payee does not desire to add restrictions, the payor clicks “create secure digital check.” If the payor desires to enter restrictions the payor enters approved use of the funds or for what the funds can be used for such as: Food, Beverage, Television, or Merchant 1 Computer. The payor then enters merchant, manufacturer, or category exclusions. The bank displays restriction codes associated with each different merchant, manufacturer, and product category and identity. The payor enters the restriction code for the approved use of funds and the payor enters the restriction code for the merchant, manufacturer, or category exclusions. As shown in FIG. 4, the bank website generates a digital image containing the check document, which can be freely transferred. In the preferable embodiment, the bank attaches to the digital image an encrypted text data which contains the entered information payee, amount, payor bank account, and optionally any restrictions. Only banking institutions have the decryption sequence. The digital image can be freely transferred via email. The payee can deposit it electronically in which case the digital image is parsed to determine the encrypted data and the payee, amount, payor bank account, and optionally any restrictions which are contained in the digital image. The encrypted data is decrypted by the bank accessing a decryption database connected to the banks system. Optionally, the encrypted data is compared with the actual data and if the encrypted amount is for less than the amount of the check the check is immediately flagged for check fraud.

A payee may engage in an auto-verification process to determine if the check is written for the correct amount before sending the check. The payee scans the check into a scanning device creating an electronic image. The payee electronically sends any check containing the encryption in the digital image to any bank. The digital image is parsed to determine the encrypted data and the payee, amount, payor bank account, and optionally any restrictions which are contained in the digital image. The encrypted data is decrypted by the bank accessing a decryption database connected to the banks system. Opposed to transferring funds the payee asks for verification. The bank sends an electronic message to the payee indicating the true values of the encrypted data. This way the payee is able to know the true value of the check before the payee takes the check. In an additional embodiment, the bank to which the payee sent the check sends a balance check request to the payor's bank. The payee's bank also sends verification that sufficient funds exist for the check.

### BRIEF DESCRIPTION OF THE DRAWINGS

FIGS. 1A-1H is a description of the electronic transfer and process of restricted funds involving the creation of a separate account.

FIG. 2A-H is a description of the electronic transfer and process of restricted funds involving the account with both restricted and unrestricted funds.

FIG. 3 is an illustration of a restricted check.

FIG. 4 is an illustration of a secure digital check.

FIG. 5 is an illustration of the parsing process of a restricted check.

FIG. 6 is an illustration of the parsing process of a secure digital check.

FIG. 7A-D is an illustration of the restricted funds process for a first bank, second bank, and third bank.

FIG. 8 is an illustration of an apparatus which performs functions articulated in the patent.

FIG. 9 is an illustration of the payment processing of restricted funds by a second bank.

FIG. 10 is an illustration of the payment processing of restricted funds by a third bank.

FIG. 11 is an illustration of the payment processing of restricted funds by a first bank.

FIG. 12 is an illustration of an online bank site feature which allows for the creation of a secure digital check.

FIG. 13 is an illustration of the data entry process for the creation of a secure digital check.

FIG. 14 is an illustration of textual entry of approved uses and exclusions of those approved uses in the creation of a secure digital check.

FIG. 15 is an illustration of restricted category codes associated with categories and identities of merchants, and manufactures.

FIG. 16 is an illustration of entry of codes for approved uses and exclusions to those approved uses in the creation of a secure digital check.

FIG. 17 is an illustration of a website displaying the restricted transfer of funds option.

FIG. 18 is an illustration of the data entry process for the transfer of funds.

FIG. 19 is an illustration textual entry of the approved uses and exclusions of those approved uses for a restricted transfer of funds.

FIG. 20 is an illustration of entry of codes for approved uses of funds and exclusions to those approved uses for the restricted transfer of funds.

### I. DETAILED DESCRIPTION

A. Bank Online Process for the Restricted Transfer of Funds: Separate Account

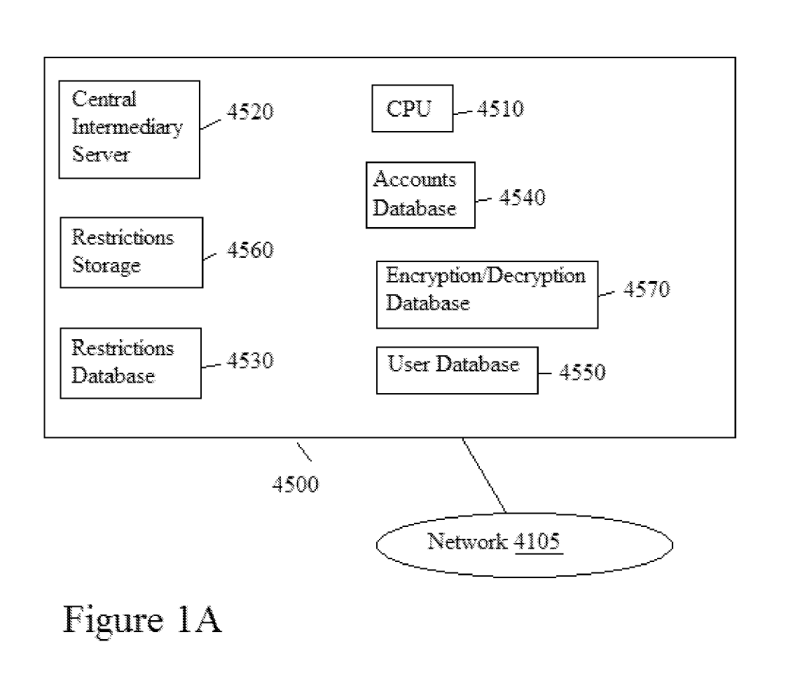

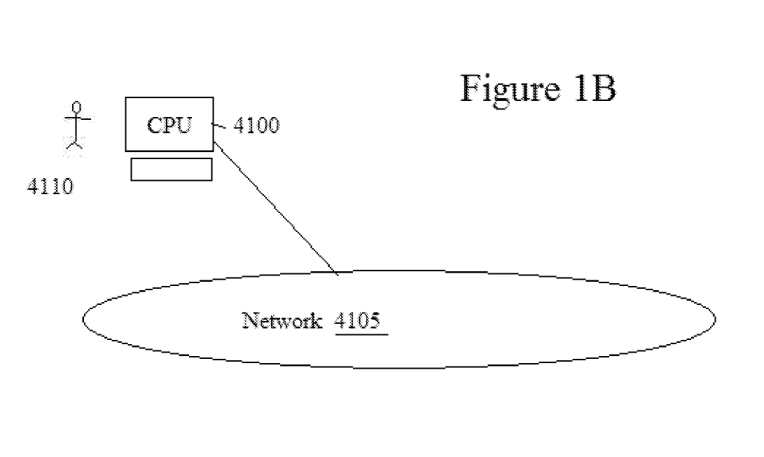

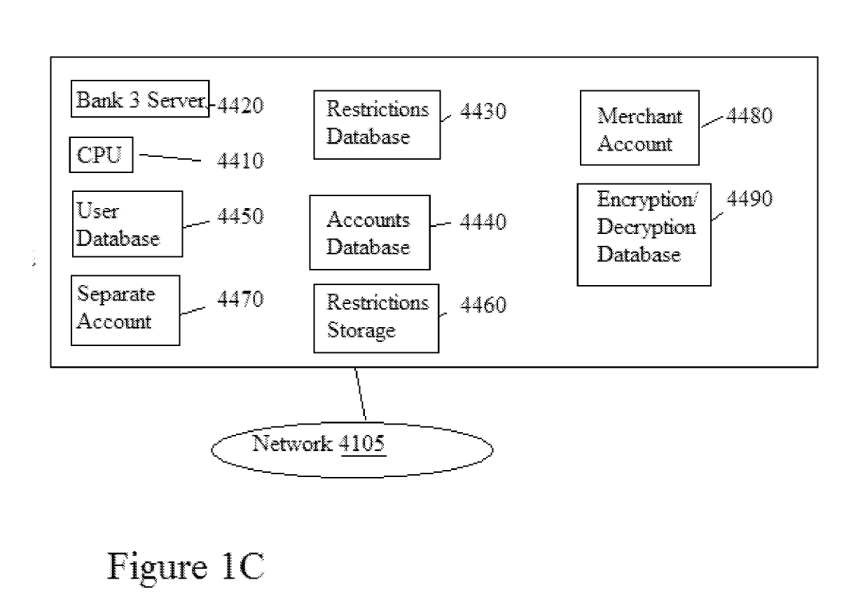

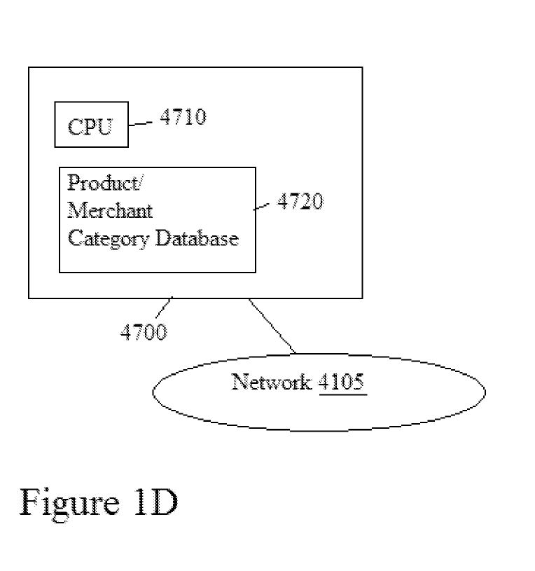

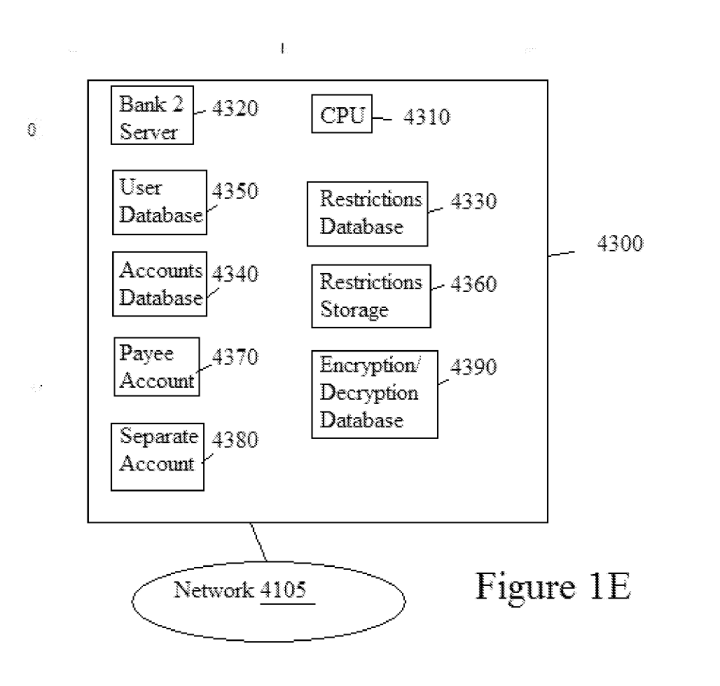

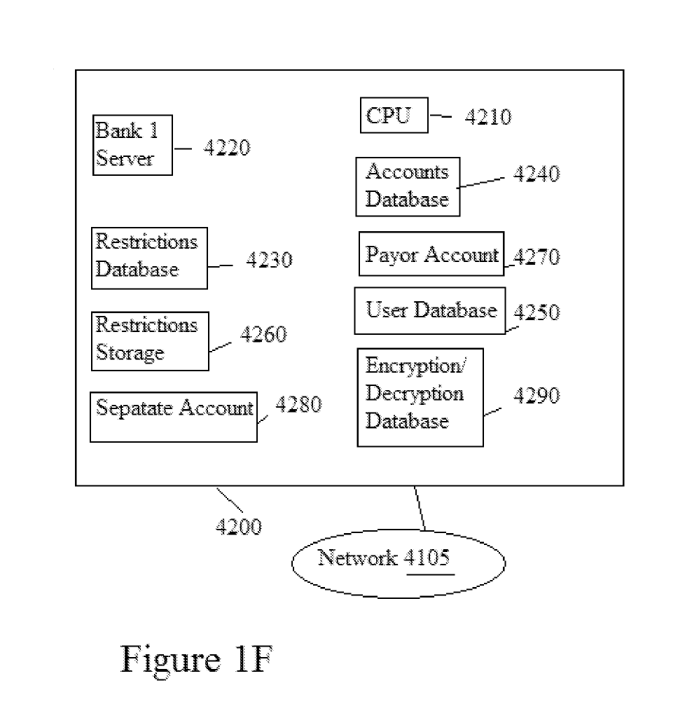

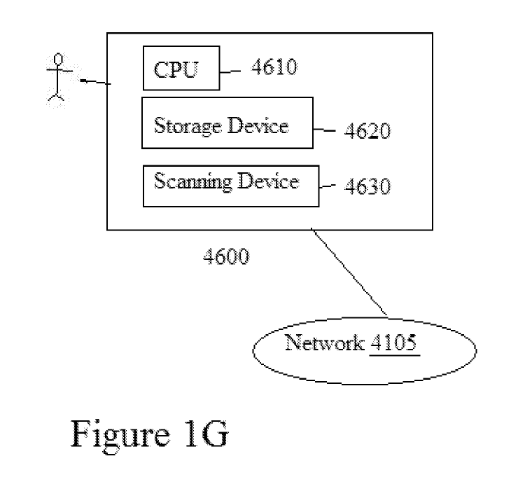

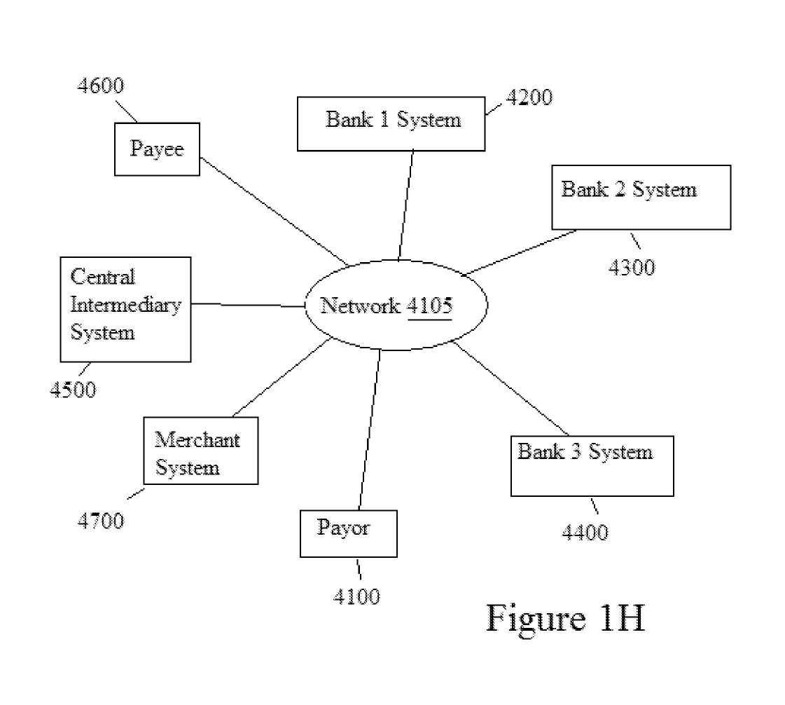

FIG. 1A contains a central intermediary bank server 4520, a central processing unit (CPU) 4510, a restrictions storage device 4560, an accounts database 4540, a restrictions database 4530, an encryption/decryption database 4570, and a user database 4550 connected to a network 4105. FIG. 1B contains a payor 4110 connected to a central processing unit 4100 with a display device and an input device connected to a network 4105. FIG. 1C contains a bank 3 server 4420, a CPU 4410, a user database 4450, a separate account 4470, a restrictions database 4430, an accounts database 4440, a restrictions storage 4460, a merchant account 4480, and an encryption/decryption database 4490 connected to a network 4105. FIG. 1D consists of a CPU 4710, a product/merchant category database 4720, connected to a network 4105. FIG. 1E consists of a bank 2 server 4320, a CPU 4310, a user database 4350, an accounts database 4340, a payee account 4370, a separate account 4380, a restrictions database 4330, restrictions storage device 4360, encryption/decryption database 4390 connected to a network 4105. FIG. 1F contains a bank 1 server 4220, a restrictions database 4230, restrictions storage 4260, separate account 4280, a cpu 4210, an accounts database 4240, a payor account 4270, a user database 4250, an encryption/decryption database 4290 connected to a network 1F. FIG. 1G contains a payee 4600, a CPU 4610, a storage device 4260, a scanning device 4630 connected to a network 4105. FIG. 1H contains a payee 4600, a bank 1 system 4200, a bank 2 system 4300, a bank 3 system 4400, a payor 4100, a merchant system 4700, a central intermediary system 4500 connected to a network 4105.

### Restriction Input

FIG. 1 illustrates the person to person online process for the restricted transfer of funds. There are two embodiments for inputting restrictions. In a first embodiment, a payor 4100 accesses a payor's bank system 4200 through a network 4105 or the internet 4105. The payor 4100 inputs an amount of the restricted transfer and inputs the restrictions to a payor's bank system. When the payor inputs restrictions, the payor inputs what category, or identity of merchant, manufacturer, or product the funds may be used for. The payor may further narrow the use of the funds by providing additional exclusions to the approved uses. The funds may not be used for any other use aside from the approved use. (Hereinafter: restrictions will be mean “only approved uses of funds.”) The restrictions which the payor can make are selected from a restrictions database 4230 connected to the payor's bank system 4200. Additionally, the payor 4100 inputs the payor's account number 4270, and the identity of the payee account 4370. Optionally, the payor 4100 inputs to the payor's bank system 4200 that the payee's bank 4300 will receive the restricted funds, the payor's bank 4200 will receive the restricted funds, or a third bank 4400 will receive the restricted transfer of funds. Optionally, the payor 4100 inputs to the payor's bank system 4200 that the restricted funds will be used before or after the funds in the payee's account 4370. In the event that there are more than one account with restricted funds that the payee has access to the payee's bank 4300 will determine the order of which restricted funds are paid for a given transaction.

In a second embodiment, a payor 4100 accesses a central intermediary bank system 4500 through a network 4105 or the internet 4105. The payor 4100 submits an mount of the restricted transfer and inputs the restrictions. The restrictions which the payor can make are selected from a restrictions database 4530 connected to the central intermediary bank system 4500. Additionally, the payor 4100 inputs to the central intermediary bank system 4500, the payor's account number 4270, and the identity of the payee account 4370. Optionally, the payor 4100 inputs to the central intermediary bank system 4500 that the payee's bank 4300 will receive the restricted funds, the payor's bank 4200 will receive the restricted funds, the central intermediary bank 4500 will receive the restricted funds, or a third bank 4400 will receive the restricted transfer of funds. The central intermediary bank 4500 sends the following information to the payor's bank: payor's bank identity 4200, payor's account number 4270, the payor's selected restrictions associated with the transfer of funds, amount of the restricted transfer, the payee's account number 4370 and identity of the depositing bank 4200, 4300, or 4400.

### Restricted Transfer Process

A process for engaging in the restricted transfer of funds from one party to another party is described in this section in three embodiments. The restrictions are inputted as described above.

In the first embodiment, the payor's bank 4200 accesses the user database 4250 and accounts database 4240 to determine the identity of the payor 4100, the identity of the payor's account 4270, the identity of the payee's bank 4300 and the payee's account 4370. In one embodiment the account database and the user database may be a single database. The payor's bank 4200 sends the following data to the payee's bank 4300: payor's bank identity 4200, payor's account number 4270, the payor's selected restrictions associated with the transfer of funds, amount of the restricted transfer, and the payee's account number 4370. The payee's bank 4300 accesses the accounts database 4340 and the user database 4350 to determine the identity of the payee and the payee's account 4370.

The payee's bank 4300 creates a separate bank account with restricted funds 4380 where the restrictions are imposed by the payor 4100. The payor's bank 4200 debits the amount of the restricted transfer from the payor's account 4270 and the payee's bank 4300 deposits the funds in a separate bank account 4380 belonging to the payee and restricted by the payor 4100. The restrictions associated with the separate account with restricted funds 4380 are stored on a restrictions storage database 4360 which is part of the payee's bank system 4300. The identity of the payor and the payee associated with the separate account with restricted funds is stored on a user database 4350. The account with restricted funds identity is stored on an accounts database 4340, which is part of the payee's bank system 4300.

The payee can access the funds in the separate account with restricted funds 4380 subject to restrictions placed on the account. When the payee's bank 4300 determines restricted funds can or will be used the payees bank 4300 withdraws funds from the separate account with restricted funds 4380 and either pays the account or entity the payee requested or transfers the funds into the payee's account 4370.

In a second embodiment, the payor's bank 4200 accesses the user database 4250 and accounts database 4240 to determine the identity of the payor 4100, the identity of the payor's bank account 4270, the identity of the payee and the payee's account 4370. In one embodiment the account database and the user database may be a single database. The payor's bank 4200 creates a separate bank account 4280 with restricted funds, where the restrictions are imposed by the payor 4100. The payor's bank 4200 debits the amount of the restricted transfer from the payor's account 4270 and the payor's bank 4200 deposits the funds in a separate bank account 4280 belonging to the payee and limited by the payor 4100. The restrictions associated with the separate account with restricted funds 4280 are stored on a restrictions storage database 4260 which is part of the payor's bank system 4200.

The separate account with restricted funds identity is stored on an accounts database 4240, which is part of the payor's bank system 4200. The identity of the payor and the payee associated with the separate account with restricted funds is stored on a user database 4250. The payee can access the funds in the separate account 4380 subject to restrictions placed on the funds. The payor's bank 4200 sends to the payee the identity of the separate account with restricted funds 4280. In one embodiment, the payor's bank 4200 sends the payee's bank 4300 the identity of the separate bank account with restricted funds 4280 and the associated payee 4600.

The payee withdraws funds normally from her bank 4300. When the payee's bank 4300 determines restricted funds can or will be used the payees bank 4300 contacts the payor's bank 4200 and asks for a transfer of funds. The transfer of funds can be from the separate bank account with restricted funds 4280 to the payee's account 4370 or from the separate bank account with restricted funds 4280 to an account or entity the payee 4600 has specified on the payee's 4600 behalf. Optionally, the payee 4600 stores the separate account data on a storage device 4260 connected to the payee's cpu 4610.

In a third embodiment, the payor's bank 4200 accesses the user database 4250 and accounts database 4240 to determine, the identity of the payor 4100, the identity of the payor's bank account 4270, the identity of the third bank 4400, the identity of the payee 4600 and the payee's account 4370. In one embodiment the account database and the user database may be a single database. The payor's bank 4200 sends the following data to a third bank 4400 which does not have an account belonging to the payor 4100 or the payee 4600: payor's bank identity 4200, payor's account number 4270, the payor's selected restrictions associated with the transfer of funds, amount of the restricted transfer, the payee's bank identity 4300, and the payee's account number 4370.

The third bank 4400 accesses the accounts database 4440 and the user database 4450 to determine the identity of the payee 4600 and the payee's account 4370. The third bank 4400 creates a separate bank account 4470 for the restricted funds, where the restrictions are imposed by the payor 4100. The payor's bank 4200 debits the amount of the restricted transfer from the payor's account 4270 and the third bank 4400 deposits the funds in a separate bank account with restricted funds 4470 belonging to the payee 4600 and the payor 4100. The restrictions associated with the separate account with restricted funds 4470 are stored on a restrictions storage database 4460 which is part of the third bank's system 4400.

The separate account with restricted funds identity is stored on an accounts database 4440, which is part of the third bank's system 4400. The identity of the payor and the payee associated with the separate account with restricted funds are stored on a user database 4450. The payee 4600 can access the funds in the separate account with restricted funds 4470 subject to restrictions placed on the account. The payor's bank 4200 and/or the third bank 4400 send to the payee 4600 the identity of the separate account with restricted funds 4470. In one embodiment, the third bank 4400 sends the payor's bank 4200 and the payee's bank 4300 the identity of the separate bank account with restricted funds 4470 and the associated payee 4600 and payor 4100. The payee withdraws funds normally from her bank 4300, when the payee's bank 4300 determines restricted funds can or will be used the payees bank 4300 contacts the third bank 4400 and asks for a transfer of funds.

The transfer of funds can be from the third bank 4400 to the payee's account 4370 or from the third bank 4400 to an account or entity the payee 4600 has specified on the payee's 4600 behalf. Optionally, the payee 4600 stores the separate account data on a storage device 4260 connected to the payee's cpu 4610.

B. Use of Restricted Funds Account with Restricted Funds Only:

When a merchant 4700 submits a purchase request to the payee's bank 4300 on behalf of the payee 4600 the following steps transpire. The merchant 4700 sends the item or service category that the payee is attempting purchasing and the payee's bank account 4370 to the payee's bank 4300. The merchant 4700 may send a category code associated with a particular purchase by accessing a product and merchant category code database 4720 connected to the merchant's system. Alternatively, the merchant or alternatively send a text description of the item or service.

A computer program operating on the payee's bank system 4300 then accesses the accounts database 4340 to determine the accounts with restricted funds 4380 associated with the payee's main account 4370. A computer program operating on the payee's bank system 4300 then accesses the restrictions storage database 4360 to determine the restrictions associated with the account with restricted funds 4380 and if the restricted funds are to be used before or after the unrestricted funds or payees main account 4370.

A computer program operating on the payee's bank system 4300 then compares the category code associated with a particular purchase or merchant and the restrictions associated with the funds in the separate account 4380. In the embodiment where the merchant sends a text description of the purchase or the merchant category, a computer program operating on the merchant system 4700 or the payee's bank system 4300 uses an advanced algorithm to translate the text description into an appropriate category code.

If the category for the restricted funds is approved, the amount of the restricted funds is sufficient to pay the requested purchase, and the restricted funds have priority the payee's bank 4300 withdraws money from the payee's separate account 4380 and transfers it to the merchant's bank account 4480. (The merchant bank account can be with any bank, the payee bank 4300, the payor bank 4200, a third bank 4400, or some additional bank [not shown].) In the event that the funds are insufficient the payee's bank 4300 attempts to withdraw unrestricted funds necessary to cover the expense from the payees other account 4370.

In the event, the category is not approved, the payee's bank 4300 denies transfer of the restricted funds and transfers unrestricted funds from the payees account 4370. In the event that all funds are insufficient or the category is not approved and the unrestricted funds are insufficient, the payee's bank denies the transaction.

In the event that the separate bank account is stored at the payor's bank 4200 or a third bank 4400, one of the following options transpire. First, the payee 4600 receives a method of accessing funds directly from the separate account at payor's bank 4280 or the third bank 4470. In this embodiment, the process articulated above is repeated for the payor's bank 4200 or the third bank 4300. Second, the payee 4600 withdraws funds normally from her bank 4300, when the payee's bank 4300 determines restricted funds can or will be used the payees bank 4300 contacts the third bank 4400 or the payor's bank 4200 and asks for a transfer of funds.

The transfer of funds can be from the third bank 4400 or payor's bank 4200 to the payee's account 4370 or from the third bank 4400 or payor's bank 4200 to an account or entity the payee 4600 has specified on the payee's 4600 behalf. Prior to transferring the funds the payee's bank 4300 transfers the category or identity of the item or the merchant, the amount of the transfer, and the merchant identity to the payor's bank 4200 or the third bank 4400. The payee's bank 4300 may transfer to the third bank 4400 or the payor's bank 4200 a category code or a text description of the merchant or purchase category.

In one embodiment, the payee's bank can perform a restriction check and then send the approval to the third bank 4400 or the payor's bank 4200 without sending the payor's bank 4200 or the third bank 4400 the restriction data. The payee's bank sends a restriction approval code to the third bank 4400 or the payor's bank 4200. In this embodiment, the third bank 4400 or payor's bank 4200 transfers funds from account 4280 or account 4470 to the merchant account 4480 or to the payee's bank 4300. If the funds are transferred from the third bank 4400 or the payor's bank 4200 to the payee's bank 4300 the payee's bank pays the merchant 4480.

In an additional embodiment, a computer program operating on the payor's bank system 4200 or the third bank's system 4400 then accesses the accounts database 4440 or 4240 to determine the accounts with restricted funds 4280 or 4470 associated with the payee's main account 4370. A computer program operating on the payor's bank system 4200 or the third bank's system 4400 then accesses the restrictions storage database 4460 or 4260 to determine the restrictions associated with the separate account with restricted funds 4470 or 4280 and if the restricted funds are to be used before or after the unrestricted funds or payee's main account 4370.

A computer program operating on the payor's bank system 4200 or the third bank's system 4400 then compares the category code associated with a particular purchase or merchant and the restrictions associated with the funds in the separate account 4280 or 4470. In the embodiment where the merchant 4700 sends a text description of the purchase or the merchant category, a computer program operating on the merchant system 4700 or any bank system (4200, 4300, 4400 uses an advanced algorithm to translate the text description into an appropriate category code.

If the category for the restricted funds is approved, the amount of the restricted funds is sufficient to pay the requested purchase, and the restricted funds have priority the payor's bank system 4200 or the third bank's system 4400 withdraws money from the payee's separate account 4280 or 4470 and transfers it to the merchant's bank account 4480. (The merchant bank account can be with any bank, the payee bank 4300, the payor bank 4200, a third bank 4400, or some additional bank [not shown].) In the event the funds are insufficient, the third bank 4400 or the payor bank 4200 sends an electronic message to the payee's bank 4300, and the payee's bank 4300 attempts to withdraw the excess funds from payee's other account 4370.

In the event, the category is not approved, the third bank 4400 or the payor's bank 4200 denies transfer of the restricted funds and instructs the payee's bank 4300 to transfers unrestricted funds from the payees account 5380. In the event that all funds are insufficient or the category is not approved and the unrestricted funds are insufficient, the payee's bank 4300, the third bank 4400, or the payor's bank 4200 denies the transaction.

C. Bank Online Process for Restricted Transfer of Funds: Account with Restricted and Unrestricted Funds

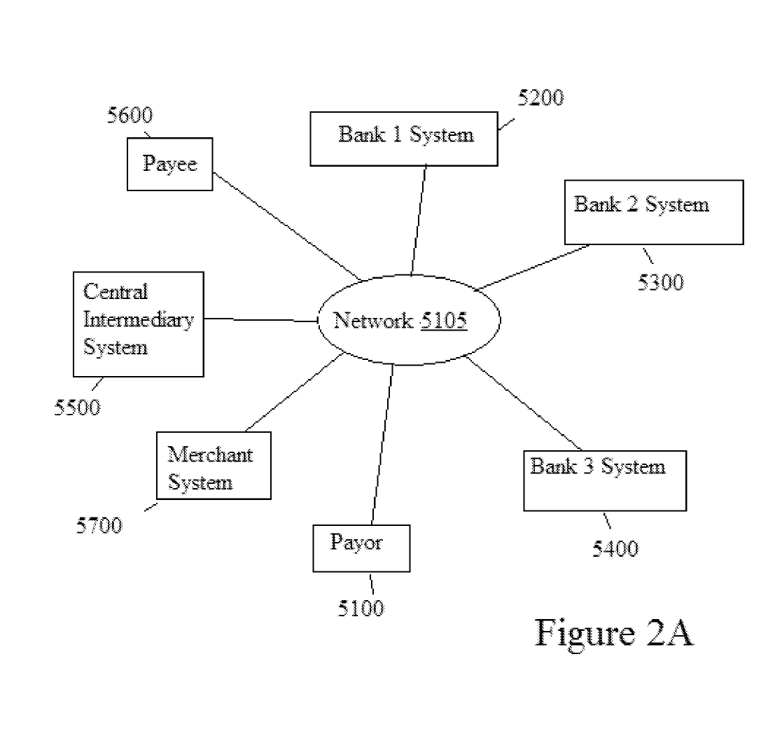

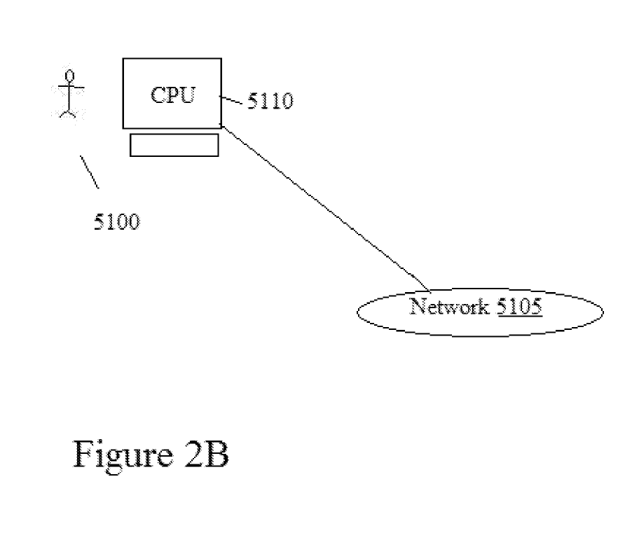

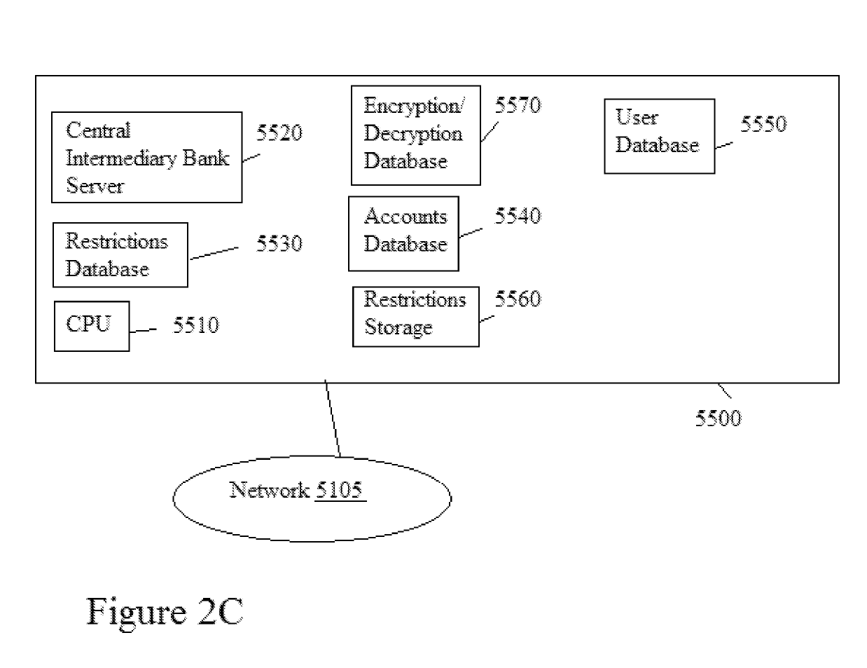

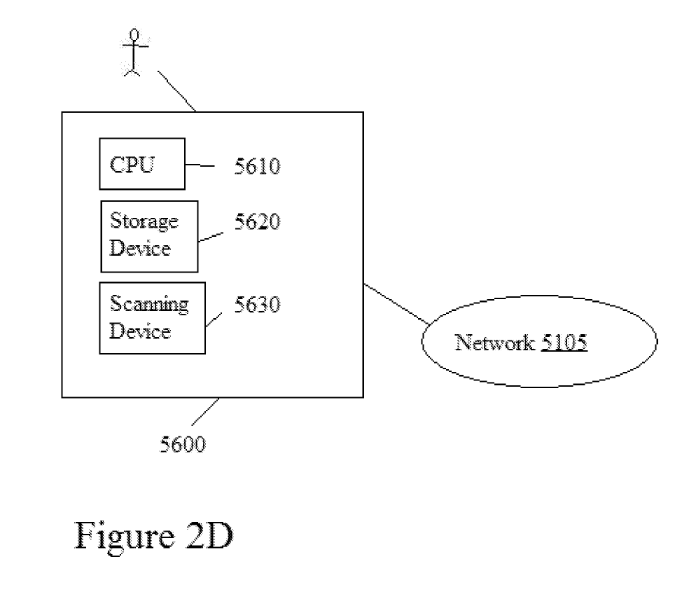

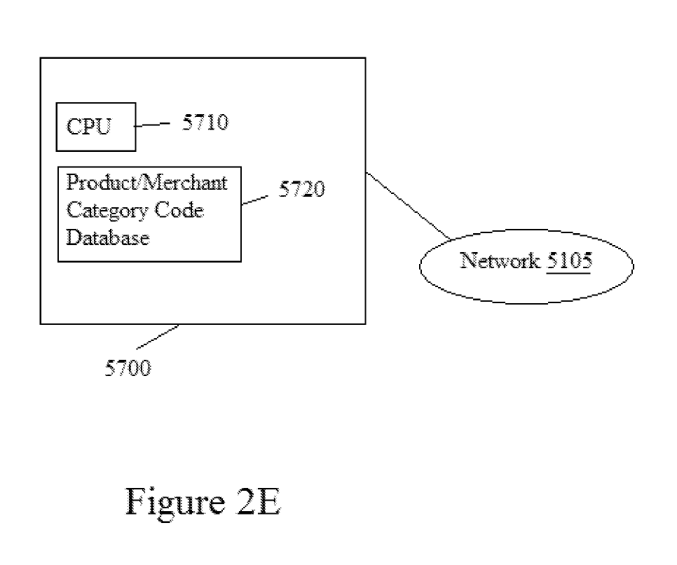

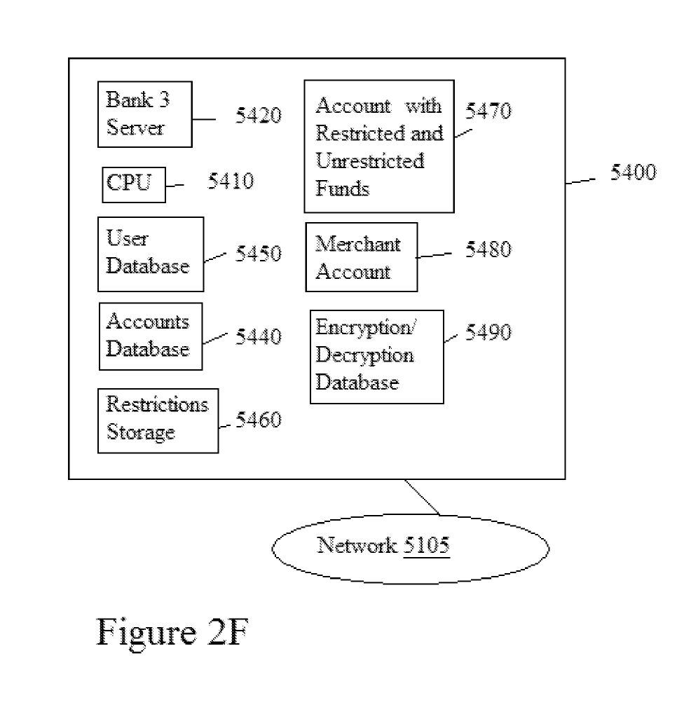

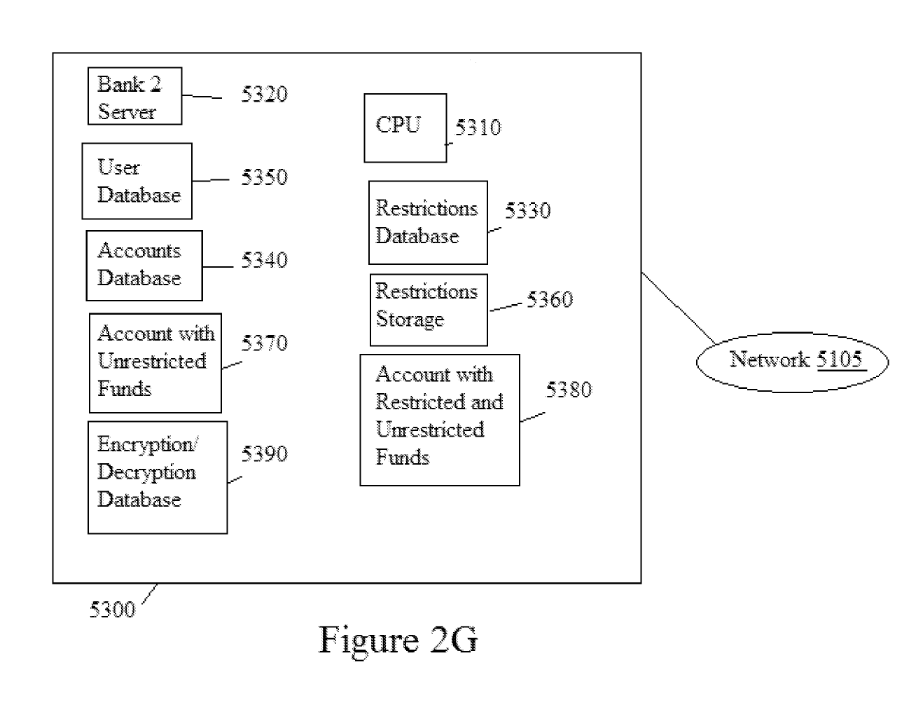

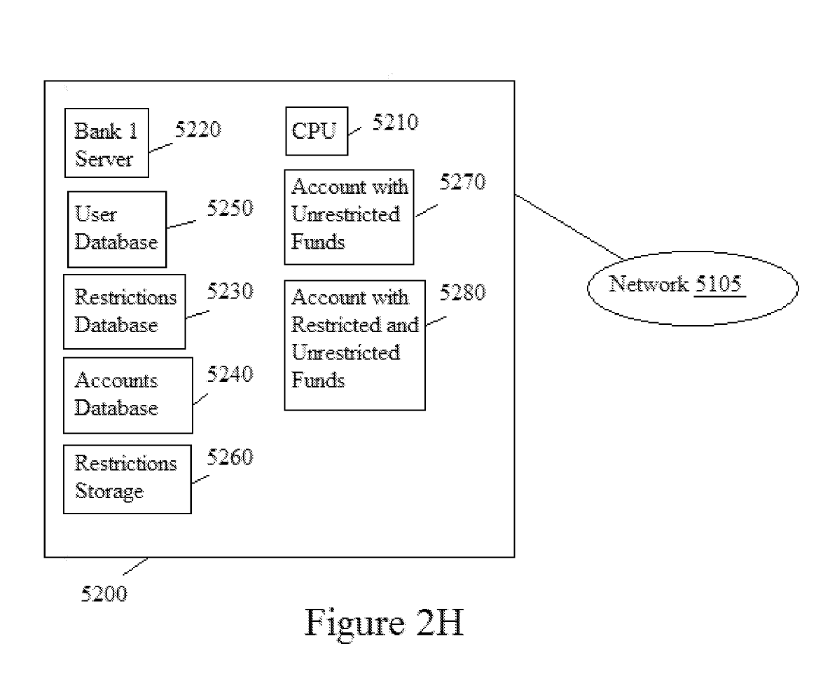

FIG. 2A contains a payee 5600, Bank 1 system 5200, bank 2 system 5300, bank 3 system 5400, payor 5100, merchant system 5700, central intermediary system 5500 connected to a network 5105. FIG. 2B consists of a payor 5100 a computer with a central processing unit, display and input device 5110 connected to a network 5105. FIG. 2C contains a central intermediary bank server 5520, a restrictions database 5530, a cpu 5510, an encryption/decryption database 5570, an accounts database 5540, a restrictions storage 5560, a user database 5550 connected to a network 5105. FIG. 2D consists of a payee 5600, a cpu 5610, a storage device 5620, a scanning device 5630 connected to a network 5105. FIG. 2E consists of a CPU 5710, a product/merchant category code database 5720 connected to a network 5105. FIG. 2F consists of a bank 3 server 5420, a cpu 5410, a user database 5450, an accounts database 5440, a restrictions storage device 5460, an account with restricted an unrestricted funds 5470, a merchant account 5480, an encryption/decryption database 5490 connected to a network 5105. FIG. 2G consists of a bank 2 server 5320, a user database 5350, an accounts database 5340, an account with unrestricted funds 5370, an encryption/decryption database 5390, a CPU 5310, a restrictions database 5330, a restrictions storage 5360, an account with restricted and unrestricted funds 5380 connected to a network 5105. FIG. 2H consists of a bank 1 server 5220, a user database 5250, a restrictions database 5230, an accounts database 5240, a storage device for restrictions 5260, a CPU 5210, an account with unrestricted funds 5270, and an account with restricted and unrestricted funds 5280 connected to a network 5105.

### Inputting Restrictions

FIG. 2 illustrates the bank online process for the restricted transfer of funds with a single account with restricted and unrestricted funds. There are two embodiments for the inputting of restrictions. In a first embodiment, a payor 5100 accesses a payor's bank system 5200 through a network 5105 or the internet 5105. The payor 5100 submits an amount of the restricted transfer and inputs the restrictions. The restrictions which the payor can make are selected from a restrictions database 5230 connected to the payor's bank system 5200. Additionally, the payor 5100 inputs the payor's account number 5270, and the identity of the payee account 5370. Optionally, the payor 5100 inputs to the payor's bank system 5200 that the payee's bank 5300 will receive the restricted funds, the payor's bank 5200 will receive the restricted funds, or a third bank 5400 will receive the restricted transfer of funds.

In a second embodiment, a payor 5100 accesses a central intermediary bank system 5500 through a network 5105 or the internet 5105. The payor 5100 submits an amount of the restricted transfer and inputs the restrictions. The restrictions which the payor can make are selected from a restrictions database 5530 connected to the central intermediary bank system 5500. Additionally, the payor 5100 inputs the payor's account number 5270, and the identity of the payee account 5370 to the central intermediary bank system 5500. Optionally, the payor 5100 inputs to the central intermediary bank system 5500 that the payee's bank 5300 will receive the restricted funds, the central intermediary bank 5500 will receive the restricted funds, the payor's bank 5200 will receive the restricted funds, or a third bank 5400 will receive the restricted transfer of funds.

The central intermediary bank 5500 sends the following information to the payor's bank: payor's bank identity 5200, payor's account number 5270, the payor's selected restrictions associated with the transfer of funds, amount of the restricted transfer, the payee's account number 5370 and identity of the depositing bank 5200, 5300, 5500 or 5400.

Restricted Transfer Process for Accounts with Restricted and Unrestricted Funds:

A process for engaging in the restricted transfer of funds from one party to another party is described in this section in three embodiments. The restrictions are inputted as described above.

In the first embodiment, the payor's bank 5200 accesses the user database 5250 and accounts database 5240 to determine the identity of the payor 5100, the identity of the payor's account 5270, the identity of the payee 5600 and the payees account 5370. In one embodiment the account database and the user database may be a single database. The payor's bank 5200 sends the following data to the payee's bank 5300: payor's bank identity 5200, payor's account number 5270, the payor's selected restrictions associated with the transfer of funds, amount of the restricted transfer, and the payee's account number 5370.

The payee's bank 5300 accesses the accounts database 5340 and the user database 5350 to determine the identity of the payee 5600 and the payee's account 5370. The payee's bank 5300 alters the payee's unrestricted bank account 4370 to reflect the restrictions imposed by the payor 5100. Unrestricted bank account 5370 becomes an account with restricted and unrestricted funds 5380. The payor's bank 5200 debits the amount of the restricted transfer from the payor's account 5270 and the payee's bank 5300 deposits the funds in the account with restricted and unrestricted funds 5380 belonging to the payee 5600 and with the restrictions imposed by the payor 5100. The restrictions associated with the account with restricted and unrestricted funds 5380 are stored on a restrictions storage database 5360 which is part of the payee's bank system 5300. The identity of the payor and the payee associated with the account with restricted funds is stored on a user database 5350. The account with unrestricted and restricted funds identity is stored on an accounts database 5340, which is part of the payee's bank system 5300.

An account with restricted and unrestricted funds bank account provides restrictions for the use of a certain amount of funds which have been transferred to account with restrictions. For example, suppose the payor 5100 indicates a restriction including the right of the payee 5600 to use the money for clothes and transfers 100 dollars. The funds are transferred from the payor's account 5270 to the payee's account 5380 with a restriction that the payee 5600 is only entitled to make purchases for clothes. The payee 5600 can't access the 100 dollar principal amount for any other types of purchases except for clothes. However, the payee 5600 can access other unrestricted funds in the account for any type of purchase.

In a second embodiment, the payor's bank 5200 accesses the user database 5250 and accounts database 5240 to determine the identity of the payor 5100, the identity of the payor's unrestricted bank account 5270, the identity of the payee 5600 and the payee's account 5370. In one embodiment the account database and the user database may be a single database. The payor's bank 5200 creates an account with restricted and unrestricted funds 5280 with the restrictions imposed by the payor 5100. If the payee 5600 deposits additional unrestricted sums into the account with restricted and unrestricted funds 5280 the additional funds are not restricted.

If the payee 5600 already has an account with the payor's bank 5200 the funds are transferred to the payee's account and the payees account (not shown) becomes an account with restricted and unrestricted funds 5280. The restricted funds transferred by the payor 5100 are limited by the additional restrictions imposed by the payor 5100, while the remaining funds have no restriction. The payor's bank 5200 debits the amount of the restricted transfer from the payor's account 5270 and the payor's bank 5200 deposits the funds in an account with restricted and unrestricted funds 5280 belonging to the payee 5600 with the restrictions imposed by the payor 5100. The restrictions associated with the account with restricted and unrestricted funds 5280 are stored on a restrictions storage database 5260 which is part of the payor's bank system 5200. The account with restricted funds identity is stored on an accounts database 5240, which is part of the payor's bank system 5200. The identity of the payor 5100 and the payee 5600 associated with the account with restricted funds is stored on a user database 5250.

The payee 5600 can access the restricted funds in the account 5280 subject to restrictions placed on the account and can access all other unrestricted funds without limitation. The payor's bank 5200 sends to the payee 5600 the identity of the account with restricted and unrestricted funds 5380. Optionally, the payee 5600 stores this data on a storage device connected to a CPU on the payee's system 5600. The payee 5600 accesses the funds in the restricted and unrestricted account 5280 normally. In an alternative embodiment, the payor's bank 5200 sends notice of the account with restricted and unrestricted funds 5280 to the payee's bank 5300, which is then stored in account database 5340. The payee 5600 withdraws funds normally from her bank 5300, when the payee's bank 5300 determines restricted funds can or will be used the payees bank 5300 contacts the payor's bank 5200 and asks for a transfer of funds. The transfer of funds can be from the payor's bank 5280 to the payee's account 5370 or from the payor's bank 5280 to an account or entity the payee 5600 has specified on the payee's 5600 behalf.

In a third embodiment, the payor's bank 5200 accesses the user database 5250 and accounts database 5240 to determine, the identity of the payor 5100, the identity of the payor's bank account 5270, the identity of a third bank 5400, the identity of the payee 5600 and the payee's bank account 5370. In one embodiment the account database and the user database may be a single database. The payor's bank 5200 sends the following data to a third bank 5400 which does not have an account belonging to the payor 5100 or the payee 5600: payor's bank identity 5200, payor's account number 5270, the payor's selected restrictions associated with the transfer of funds, amount of the restricted transfer, the payee's bank identity 5300, and the payee's account number 5370. The third bank 5400 accesses the accounts database 5440 and the user database 5450 to determine the identity of the payee 5600 and the payee's account 5370. The third bank 5400 creates an account with restricted and unrestricted bank account 5470 for the payee 5600 with the restrictions imposed by the payor 5100.

If the payee 5600 adds unrestricted funds to the account with restricted and unrestricted bank account the payee is able to use the added unrestricted funds without restriction, while the restricted funds remain restricted. The payor's bank 5200 debits the amount of the restricted transfer from the payor's account 5270 and the third bank 5400 deposits the funds in the account with restricted and unrestricted funds 5470 belonging to the payee 5600 limited by the restrictions imposed by the payor 5100. The restrictions associated with the account with restricted and unrestricted funds 5470 are stored on a restrictions storage database 5460 which is part of the third bank's system 5400. The account with restricted funds identity is stored on an accounts database 5440, which is part of the third bank's system 5400.

The identity of the payor 5100 and the payee 5600 associated with the account with restricted and unrestricted funds 5470 are stored on a user database 5450. The payee 5600 can access the restricted funds in the account with restricted and unrestricted funds 5470 subject to restrictions placed on the account by the payor 5100 and access any other funds belonging to the payee without restriction. The payor's bank 5200 and/or the third bank 5400 send to the payee 5600 or the payee's bank 5300 the identity of the account with restricted and unrestricted funds 5470. Optionally, the payee 5600 stores this data on a storage device 5620 connected to the payee's system 5600. In an alternative embodiment, the third bank 5400 sends notice of the account with restricted and unrestricted funds 5470 to the payee's bank 5300, which is then stored in account database 5340.

The payee 5600 withdraws funds normally from her bank 5300, when the payee's bank 5300 determines restricted funds can or will be used the payees bank 5300 contacts the third bank 5400 and asks for a transfer of funds. The transfer of funds can be from the third bank 5470 to the payee's account 5370 or from the third bank 5470 to an account or entity the payee 5600 has specified on the payee's 5600 behalf.

D. Use of Restricted Funds by Payee for Account with Restricted and Unrestricted Funds:

When a merchant 5700 submits a purchase request to the payee's bank 5300 on behalf of the payee 5600 the following steps transpire. The merchant 5700 sends the product or merchant category or identity that the payee is attempting purchasing and the payee's bank account 5380 to the payee's bank 5300. The merchant 5700 may send a category code associated with a particular purchase by accessing a product and merchant identity and category code database 5720 connected to the merchant's system 5700. Alternatively, the merchant 5700 sends a text description of the item or service. A computer program operating on the payee's bank system 5300 then accesses the accounts database 5340 to determine the account with restricted and unrestricted funds 5380. A computer program operating on the payee's bank system 5300 then accesses the restrictions storage database 5360 to determine the restrictions associated with the account with restricted and unrestricted funds 5380 and if the restricted funds are to be used before or after the unrestricted funds.

A computer program operating on the payee's bank system 5300 then compares the category code associated with a particular purchase or merchant and the restrictions associated with the funds in the account with restricted and unrestricted funds 5380. In the embodiment where the merchant sends a text description of the purchase or the merchant category, a computer program operating on the merchant system 5700 or the payee's bank system 5300 uses an advanced algorithm to translate the text description into an appropriate category code.

If the category for the restricted funds is approved, the amount of the restricted funds is sufficient to pay the requested purchase, and the restricted funds have priority the payee's bank 5300 withdraws restricted funds from the payee's account with restricted and unrestricted funds 5380 and transfers it to the merchant's bank account 5480. (The merchant bank account can be with any bank, the payee bank 5300, the payor bank 5200, a third bank 5400, or some additional bank [not shown].) In the event that the funds are insufficient the payee's bank 5300 attempts to withdraw unrestricted funds necessary to cover the expense from the account with restricted and unrestricted funds 5380.

In the event, the category is not approved, the payee's bank denies transfer of the restricted funds and transfers unrestricted funds from the payees account 5380. In the event that all funds are insufficient or the category is not approved and the unrestricted funds are insufficient, the payee's bank denies the transaction.

In the event that the account with restricted and unrestricted funds is stored at the payor's bank 5200 or a third bank 5400, one of the following options transpire. First, the payee 5600 receives a method of accessing funds directly from the separate account at payor's bank 5280 or the third bank 5470. In this embodiment, the process articulated above is repeated for the payor's bank 5200 or the third bank 5300. Second, the payee 5600 withdraws funds normally from her bank 5300, when the payee's bank 5300 determines restricted funds can or will be used the payees bank 5300 contacts the third bank 5400 or the payor's bank 5200 and asks for a transfer of funds.

The transfer of funds can be from the third bank 5400 or payor's bank 5200 to the payee's account 5370 or from the third bank 5400 or payor's bank 5200 to an account or entity the payee 5600 has specified on the payee's 5600 behalf. Prior to transferring the funds the payee's bank 5300 transfers the category or identity of the product or the merchant, the amount of the transfer, and the merchant account identity 5480 to the payor's bank 5200 or the third bank 5400. The payee's bank 4300 may transfer to the third bank 5400 or the payor's bank 5200 a category code or a text description of the merchant or product identity or category.

In one embodiment, the payee's bank can perform a restriction check and then send the approval to the third bank 5400 or the payor's bank 5200 without sending the payor's bank 5200 or the third bank 5400 the restriction data. In this embodiment, the third bank 5400 or payor's bank 5200 transfers funds from account 5280 or account 5470 to the merchant account 5480 or to the payee's bank 5300. If the funds are transferred from the third bank 5400 or the payor's bank 5200 to the payee's bank 5300 the payee's bank pays the merchant account 5480.

In an additional embodiment, a computer program operating on the payor's bank system 5200 or the third bank's system 5400 accesses the accounts database 5440 or 5240 to determine the accounts with restricted and unrestricted funds 5280 or 5470 associated with the payee's main account 5370. A computer program operating on the payor's bank system 5200 or the third bank's system 5400 then accesses the restrictions storage database 5460 or 5260 to determine the restrictions associated with the account with restricted and unrestricted funds 5470 or 5280 and if the restricted funds are to be used before or after the unrestricted funds or payee's main account 5370.

A computer program operating on the payor's bank system 5200 or the third bank's system 5400 then compares the category code associated with a particular purchase or merchant and the restrictions associated with the funds in the payee's account with restricted and unrestricted funds 5470 or 5280. In the embodiment where the merchant 5700 sends a text description of the purchase or the merchant category, a computer program operating on the merchant system 5700 or any bank system (5200, 5300, or 5400) uses an advanced algorithm to translate the text description into an appropriate category code.

If the category or identity for the restricted funds is approved, the amount of the restricted funds is sufficient to pay the requested purchase, and the restricted funds have priority the payor's bank system 5200 or the third bank's system 5400 withdraws money from the payee's account with restricted and unrestricted funds 5280 or 5470 and transfers it to the merchant's bank account 5480. (The merchant bank account can be with any bank, the payee bank 4300, the payor bank 4200, a third bank 4400, or some additional bank [not shown].) In the event that the funds are insufficient the third bank 5400 or payor's bank attempts to withdraw unrestricted funds necessary to cover the expense from the payees account 5470 of 5280. In the event the funds are insufficient, the third bank 5400 or the payor bank 5200 sends an electronic message to the payee's bank 5300, and the payee's bank attempts to withdraw the excess funds from payee's other account 5370.

In the event, the category is not approved, the third bank 5400 or the payor's bank 5200 denies transfer of the restricted funds and transfers unrestricted funds from the payees account 5470 or 5280. In the event that all funds are insufficient or the category is not approved and the unrestricted funds are insufficient, the payee's bank 5300, the payor's bank 5200, or the third bank 5400 denies the transaction.

E. Payor's Account Restricted

In an additional embodiment, to sections A through D above, the payor 4100 or 5100 inputs the restrictions and amount of funds to restrict to the payor's bank 4200, or 5200 along with the payor's account 5270, or 4270. The payor's bank then restricts the amount of funds selected for restriction by the payor in the payor's account 4270, or 5270. The payor's unrestricted 5270 becomes a payor's account with some funds restricted 5280. If the payor restricts uses the process articulated in FIG. 1, the funds in the payor's account 4270 are transferred to a separate account with restricted funds only 4280.

Subject to any restrictions, a payor may transfer restricted funds to other restricted accounts or to other non-restricted accounts, using the processes articulated in section A to D above.

F. Description of Computer Process for Online Transfer of Funds

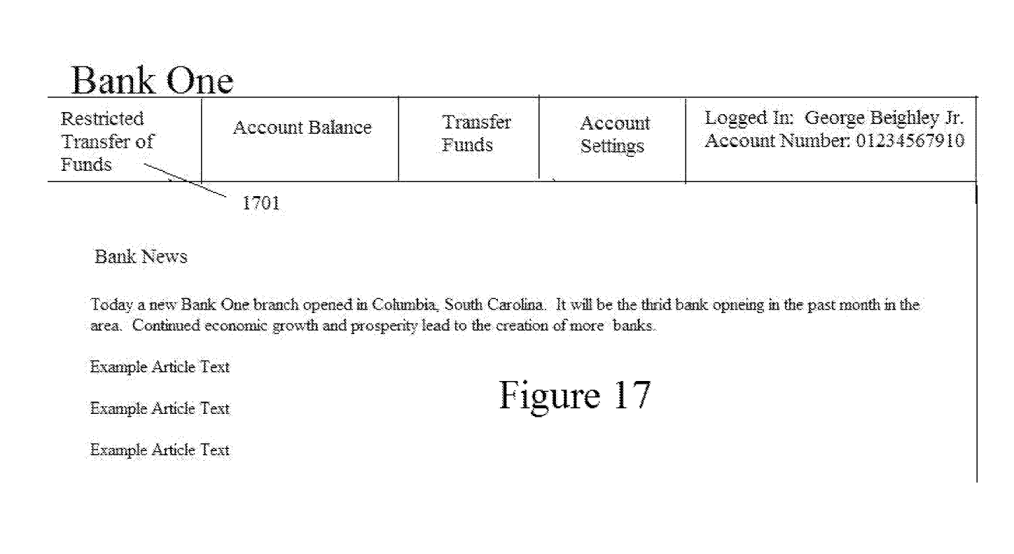

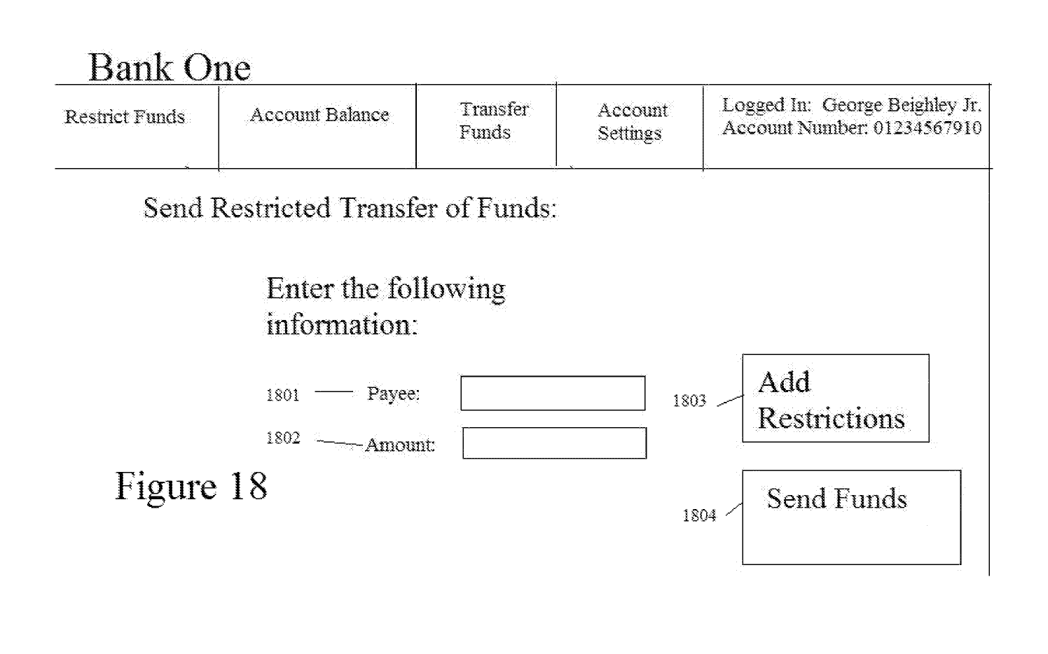

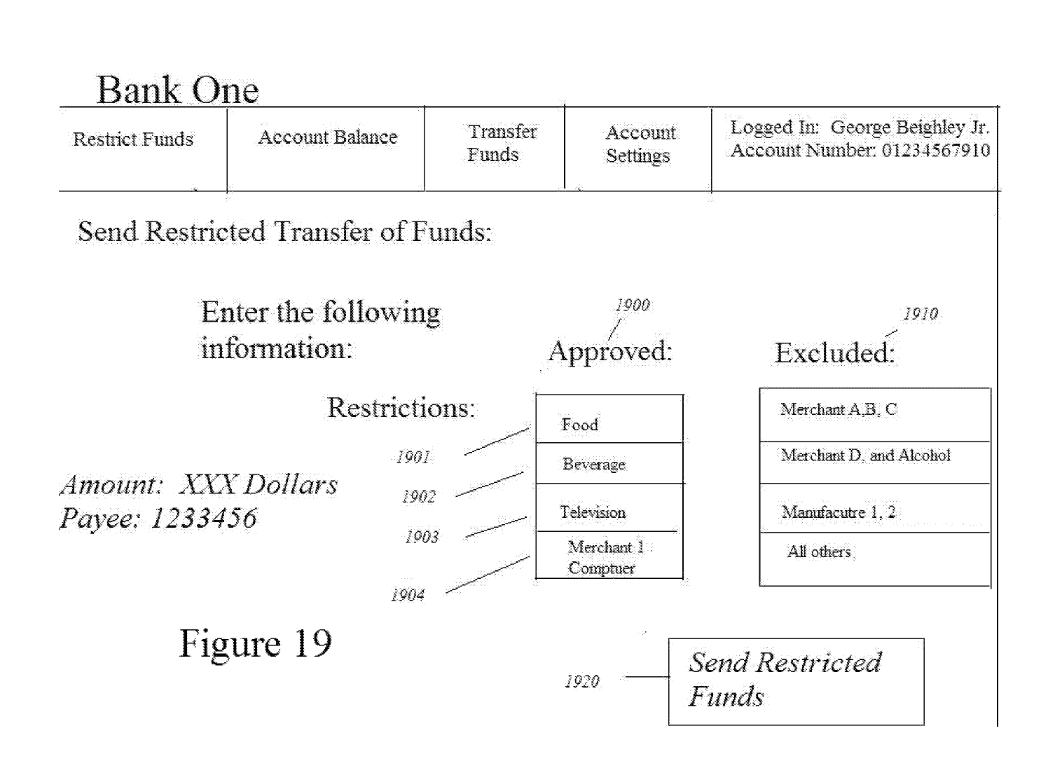

As shown in FIG. 17, a payor logs onto a payor's bank website and selects the “Restriction Transfer of Funds” link 1701. As shown in FIG. 18, a payor enters the payee account number 1801, and the amount of transfer 1802. Next, the payor either clicks “Add Restrictions” 1803 or “send funds” 1804. If the payor clicks sends funds 1804 the funds are transferred to the payee account without restrictions. FIG. 19 illustrates the embodiment where the payor clicks “add restrictions” 1803. As shown in FIG. 19, if the payor desires to enter restrictions the payor enters approved use of the funds 1900 or for what the funds can be used for such as: Food 1901, Beverage 1902, Television 1903, or Merchant 1 Computer 1904. The payor then enters merchant, manufacturer, or category exclusions 1910.

A computer program operating on the banks system compares text categories with restriction codes by accessing a restriction database and associates each text category with a restriction code. The payor 4100, 5100 clicks “Send Restricted Funds” 1920. The amount of funds, the restriction code, and payee account are sent to the payee bank.

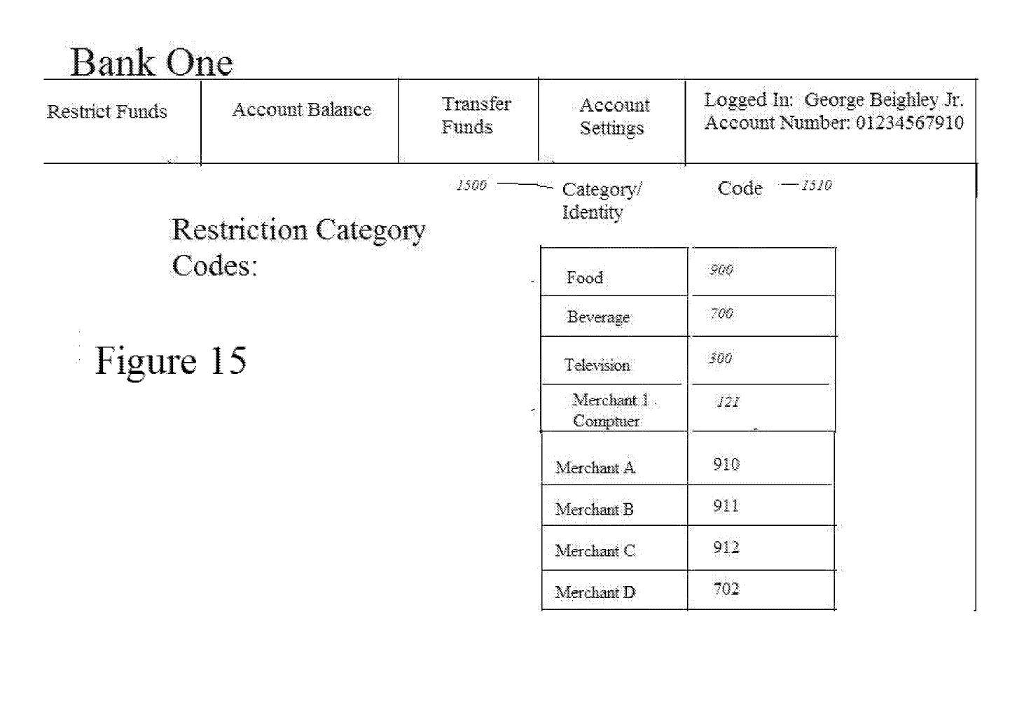

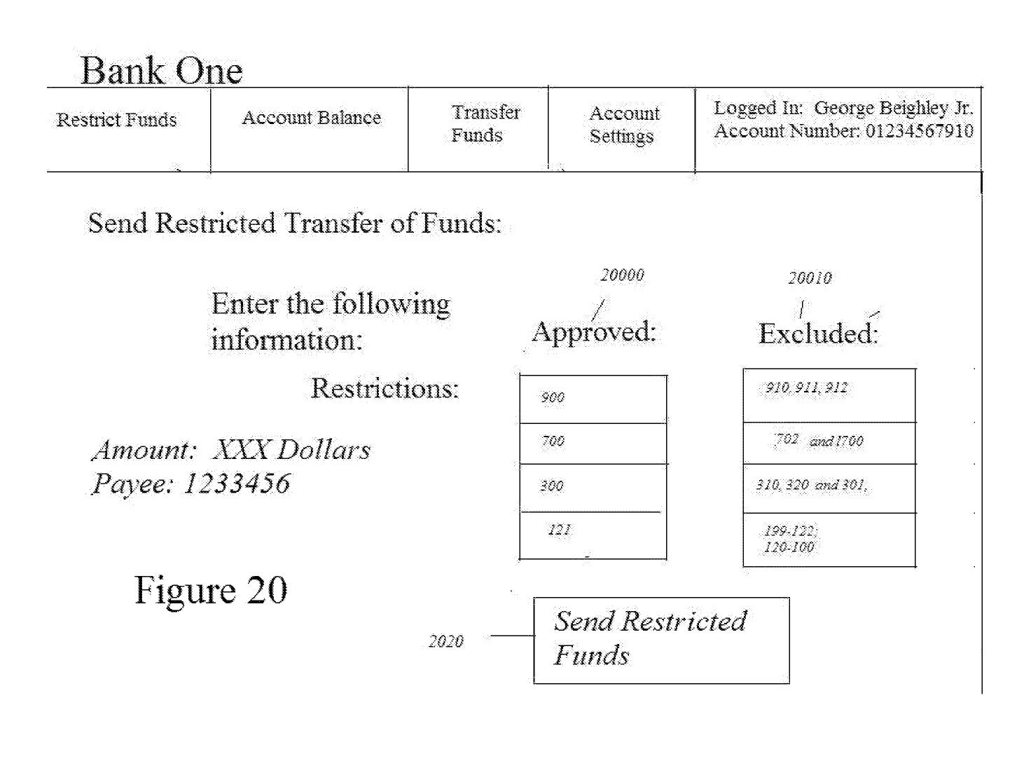

In an optional embodiment, as shown in FIG. 15, the bank displays restriction codes 1510 associated with each different merchant, manufacturer, and category of product 1500 to the payor. As shown in FIG. 20, the payor enters the restriction code for the approved use of funds 20000 and the payor enters any additional restrictions by inputting the restriction code for the merchant, manufacturer, or product category or identity 20010. The payor 4100, 5100 enters the restricted transfer amount and optionally any restrictions included with the amount. The restrictions are selected from a restriction storage database 4230, 5230 on the payor's bank system 4200, 5200. The payor 4100, 5100 clicks “Send Restricted Funds” 20020. The amount of funds, the restriction code, and payee account are sent to the payee bank.

In an additional embodiment, the bank displays restriction codes with the identity or category of the restriction. A payor types in the restriction in the form of a text entry. A computer program operating on the banks system receives the restriction accesses a restriction database, and display next to the text entry the restriction code associated with the text (Not Shown).

G. Bank Offline Electronic Process for the Restricted Transfer of Funds: Restricted Check Process

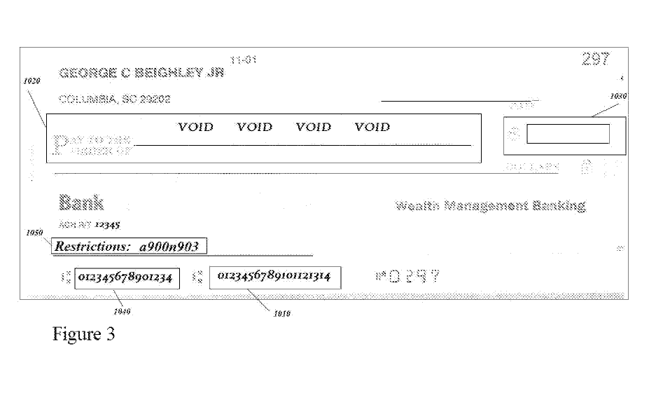

In the offline method, a payor writes a payee a restricted check and gives the check to the payee. As shown in FIG. 3: A restricted check is a typical check containing payor bank number 1010, check security procedures (not shown), payee identity 1020, amount 1030, routing number 1040, and restrictions section 1050. The payor writes the category or merchant restriction in a location contained on the check. In FIG. 3, the restriction is showing the restriction code, “a900n903” indicating approval for a certain group of merchants but not another. In an optional embodiment, the payor accesses a restriction database online 4530, 4230, 5230, 5530 containing the restrictions codes associated with different categories or merchants.

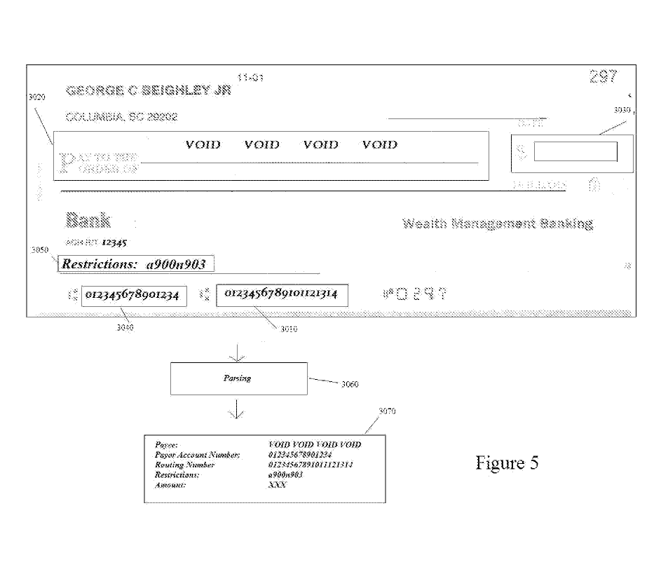

One of two processes occurs next. As in FIG. 5, the payee 4600, 5600 gives the check to a banking institution 4300, 5300 with a deposit slip. The check is scanned by a scanning device, which creates a digital image of the check. The digital image is parsed 3060 by a computer program operating on the banks system to determine the check payee 3020, the amount 3030, the identity of the payor's account 3010, check routing number 3040, and the restrictions 3050. The bank 4300, 5300 then records the parsed data 3070 on a storage device connected to the bank system. The parsed data resembles a table as shown in 3070.

The payee's bank 4300, 5300 accesses the restriction database to determine the selected restrictions associated with the check. The restrictions are stored in a restriction storage database 4360, 5360 with the payee's associated account 4380, 5380. The restricted funds are transferred to the payee's bank account 4380 or 5380. The funds are restricted in accordance with the processes described above in this patent.

Second, the payee 4600, 5600 scans the check with a scanning device creating a digital image of the check. The payee engages in an electronic transfer of the digital image to the payee's bank 4300, 5300. The digital image is parsed 3060 by a computer program operating on the banks system to determine the check payee 3020, the amount 3030, the identity of the payor's account 3010, check routing number 3040, and the restrictions 3050. The bank 4300, 5300 then records the parsed data 3070 on a storage device connected to the bank system. The parsed data resembles a table as shown in 3070.

The restrictions are stored in a restriction storage database 4360, 5360 with the payee's associated account 4380, 5380. The restricted funds are transferred to the payee's bank account 4380 or 5380.

H. Bank Online Electronic Transfer of Funds: a Secure Digital Check

In an additional method, a payor 4100, 5100 writes a payee 4600, 5600 a digital check. The payor electronically creates a check in the form of a digital image by accessing the payor's bank system 4200, 5200. Optionally, the payor 4100, 5100 enters restrictions to the check by selecting restrictions from a restriction database 4230, 5230 connected to the payor's bank system 4200, 5200. The payor saves the check as a digital image. The payor 4100, 5100 electronically sends the check to the payee 4600, 5600 via email or other form of electronic communication. The payee electronically or manually deposits the digital check.

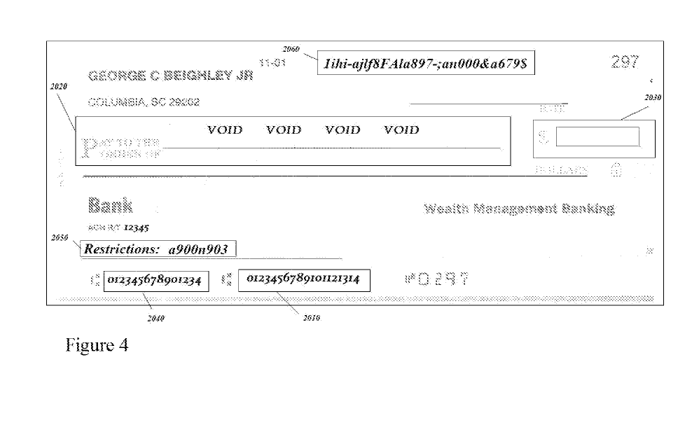

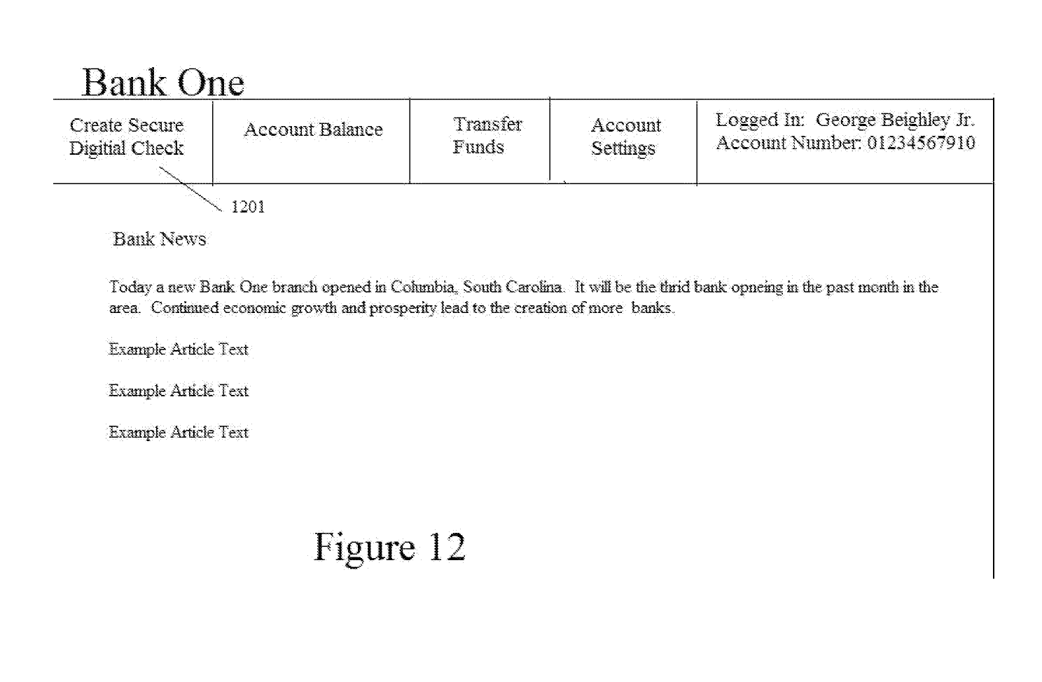

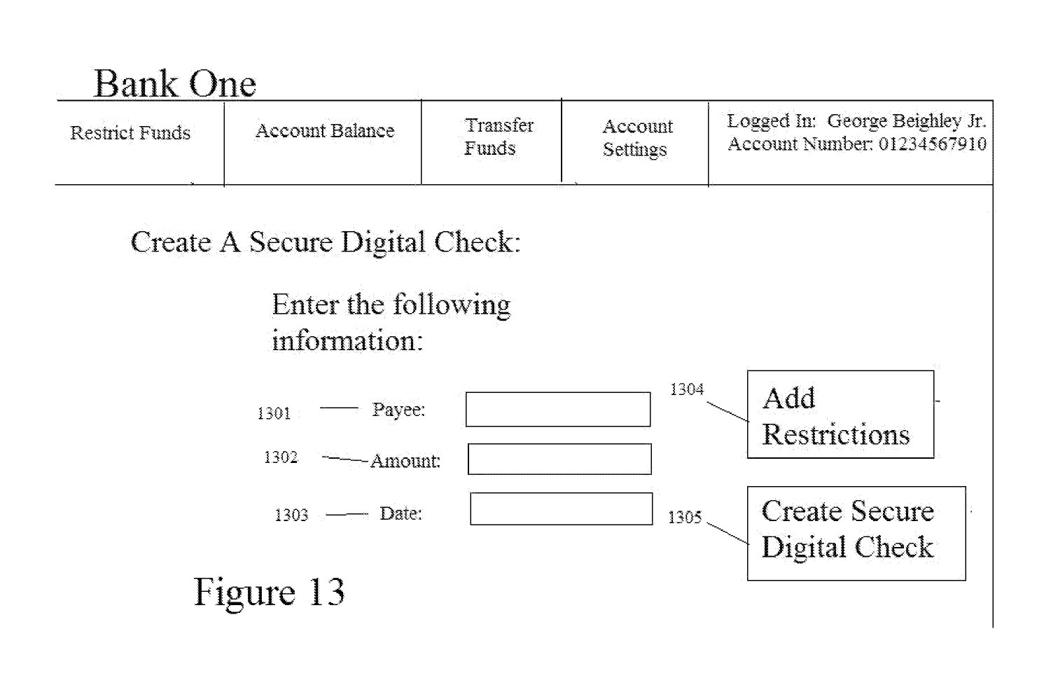

The payor 4100, 5100 logs on to a payor's banks website 4200, 5200 and selects the “Create Secure Digital Check” option. As shown in FIG. 12, the payor logs on to a banks website and selects the “Create Secure Digital Check” option 1201. As shown in FIG. 13, the payor enters the payee 1301, check amount 1302 and optionally the date 1303. If the payor desires to add restrictions the payor clicks add restrictions 1304. If the payee does not desire to add restrictions, the payor clicks “create secure digital check” 1305. The bank website 4200, 5200 generates a digital image containing the check document, which can be freely transferred. As shown in FIG. 4 a secure digital check is a typical check containing payor bank number 2010, check security procedures 2060, payee identity 2020, amount 2030, and routing number 2040. Additionally as show in FIG. 4, the payor's bank 4300, 5200 attaches to the digital image 2000 an encrypted text data 2060 which contains the entered information payee, amount, payor bank account, and optionally any restrictions. The payor's bank 4200, 5200 accesses an encryption/decryption database 4290, 5290 connected to the payor's bank system to encrypt the check.

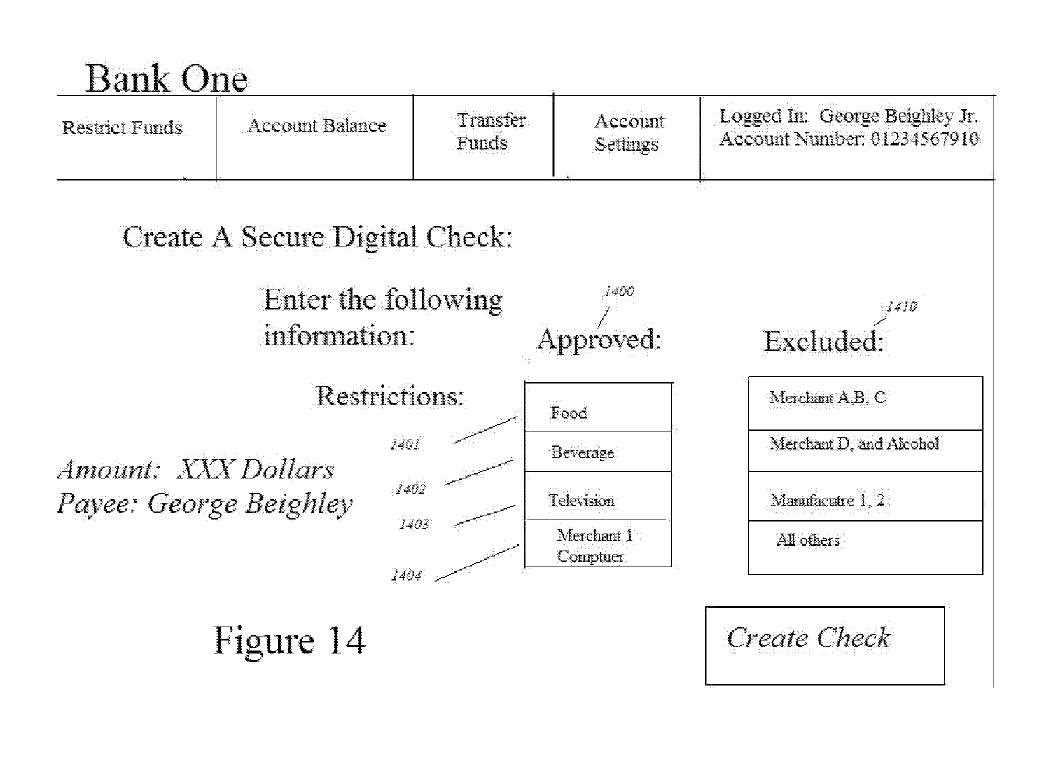

As shown in FIG. 14, if the payor desires to enter restrictions the payor enters approved use of the funds 1400 or for what the funds can be used for such as: Food 1401, Beverage 1402, Television 1403, or Merchant 1 Computer 1404. The payor then enters further restrictions including merchant, manufacturer, or product identity or categories 1410. For example, the further restriction could permit the use of all beverages except alcohol. A computer program operating on the banks system compares text categories with restriction codes by accessing a restriction database and associates each text category with a restriction code. A payor 4100, 5100 then clicks “create check” to create a secure digital check. The bank website 4200, 5200 generates a digital image containing the check document, which can be freely transferred. As shown in FIG. 4 a secure digital check is a typical check containing payor bank number 2010, check security procedures 2060, payee identity 2020, amount 2030, routing number 2040, and restrictions section 2050. Additionally as show in FIG. 4, the payor's bank 4300, 5200 attaches to the digital image 2000 an encrypted text data 2060 which contains the entered information payee, amount, payor bank account, and optionally any restrictions. The payor's bank 4200, 5200 accesses an encryption/decryption database 4290, 5290 connected to the payor's bank system to encrypt the check.

In an optional embodiment, as shown in FIG. 15, the bank displays restriction codes 1510 associated with each different merchant, manufacturer, and category of product 1500. In an additional embodiment, the bank displays restriction codes with the identity or category of the restriction. A payor types in the restriction in the form of a text entry. A computer program operating on the banks system receives the restriction accesses a restriction database, and display next to the text entry the restriction code associated with the text (Not Shown).

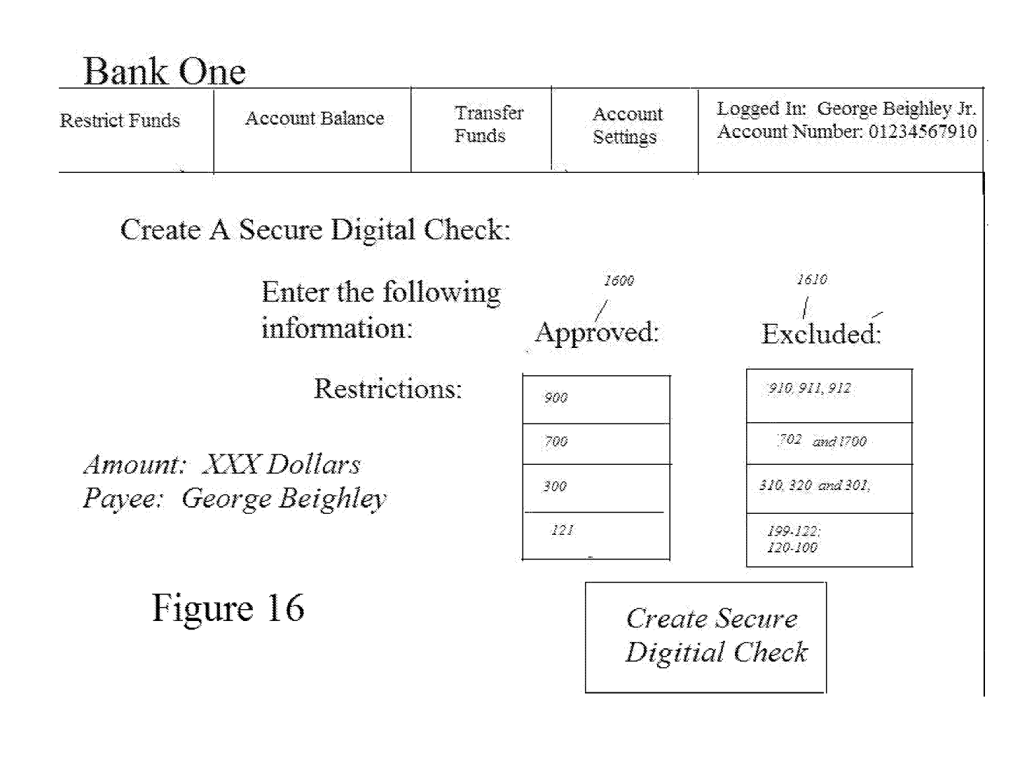

As shown in FIG. 16, the payor enters the restriction code for the approved use of funds 1600 and the payor enters the restriction code for the merchant, manufacturer, or category exclusions 1610. The payor 4100, 5100 enters the check amount and optionally any restrictions included with the amount. The payor then clicks “create a secure digital check.” The restrictions are selected from a restriction storage database 4230, 5230 on the payor's bank system 4200, 5200. The bank website 4200, 5200 generates a digital image containing the check document, which can be freely transferred. As shown in FIG. 4 a secure digital check is a typical check containing payor bank number 2010, check security procedures 2060, payee identity 2020, amount 2030, routing number 2040, and restrictions section 2050. Additionally as show in FIG. 4, the payor's bank 4300, 5200 attaches to the digital image 2000 an encrypted text data 2060 which contains the entered information payee, amount, payor bank account, and optionally any restrictions. The payor's bank 4200, 5200 accesses an encryption/decryption database 4290, 5290 connected to the payor's bank system.

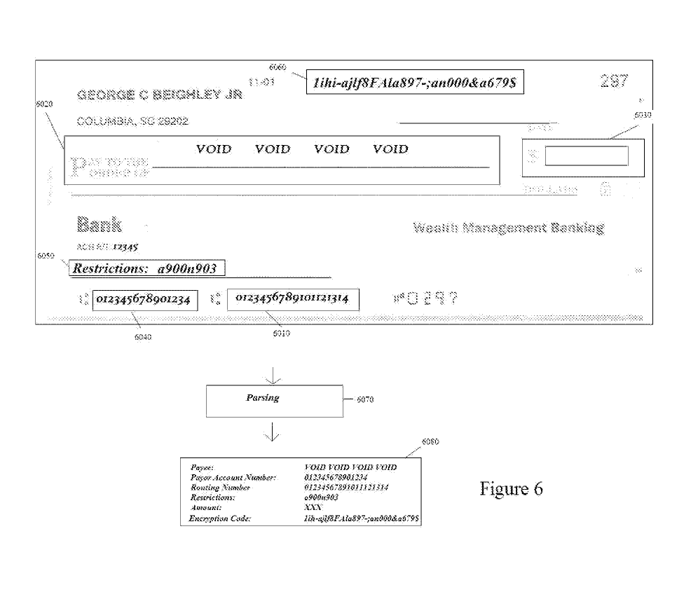

Only banking institutions 4200, 4300, 4400, 4500, 5200, 5300, 5400, or 5500 have the decryption sequence, which is stored in an encryption/decryption database connected to the banks system 4290, 4390, 4490, 4570, 5290, 5390, 5490, or 5570. The digital image can be freely transferred via email. The payee can deposit it electronically. As shown in FIG. 6, the digital image is parsed 6070. The following data is recorded: the encrypted data 6060 and the payee 6020, amount 6030, payor bank account 6010, routing number 6040 and optionally any restrictions 6050 which are contained in the digital image. The encrypted data is decrypted by the payee's bank 4300, 5300 accessing an encryption/decryption database 4390, 5390 connected to the payee's banks system. Optionally, the encrypted data is compared with the actual data and if the encrypted amount is for less than the amount of the check the check is immediately flagged for check fraud. The bank 4300, 5300 then records the parsed data 6070 on a storage device connected to the bank system. The parsed data resembles a table as shown in 6070.

Optionally, the payee 4600, 5600 prints the check and deposits it at the payee's banking institution 4300, 5300. In this embodiment the bank performs the same parsing process articulated in FIG. 6.

I. Secure Digital Check: Auto-Verification Process:

A payee 4600, 5600 may engage in an auto-verification process to determine if the check is written for the correct amount before accepting the check. The payee 4600, 5600 scans the check into a scanning device 4630, 5630 creating an electronic image. The payee 4600, 5600 electronically sends any check containing the encryption in the digital image to any bank 4200, 4300, 4400, 4500, 5200, 5300, 5400, or 5500. As shown in FIG. 6, the bank parses 6070 the digital image to determine the encrypted data 3060 and the payee 6020, amount 6030, payor bank account 6010, the routing number 6040, and optionally any restrictions 6050 which are contained in the digital image. The encrypted data is decrypted by the bank accessing an encryption/decryption database 4290, 4390, 4490, 4570, 5290, 5390, 5490, or 5570 connected to the banks system.

Opposed to transferring funds the payee 4600, 5600 asks for verification of the check amount and funds. The bank 4200, 4300, 4400, 4500, 5200, 5300, 5400, or 5500 sends an electronic message to the payee 4600, 5600 indicating the true values of the encrypted data. This way the payee is able to know the true value of the check before the payee accepts the check for payment. In an additional embodiment, the bank to which the payee sent the check sends a balance check request to the payor's bank 4200, 5200, which responds to the verification bank. The verification bank 4200, 4300, 4400, 4500, 5200, 5300, 5400, or 5500 sends verification that sufficient funds exist for the check to the payee 4600, 5600.

In an optional embodiment, the verification banks 4200, 4300, 4400, 4500, 5200, 5300, 5400, or 5500 sends the encrypted data to the payor's bank 4200, 5200 requesting decryption. The payor's bank 4200, 5200 decrypts the data and sends the verification bank the following information: the payee 6020, amount 6030, payor bank account 6010, the routing number 6040, and optionally any restrictions 6050 which are contained in the digital image. The verification bank then sends this information to the payee prior to the payee accepting the check.

J. Restriction Codes: Category Restriction

A restriction code is an electronic message sent from an individual to a banking institution or from a banking institution to another banking institution along with other financial data. A restriction code contains two types of elements: an action element and a merchant, manufacturer or product category or identity element. The action element consists of a letter such as “a” which indicates that the funds are to use for only what follows. The merchant, manufacturer or product category or identity can be some combination of numbers. For example the restriction code “a900” would mean that the transferred funds are approved for only merchants with in the 900 category such as food merchants. There are other action elements such as “n” indicating “but not,” or “p” indicating “product,” or the letter “o” indicating “only.” There are numerous other possible action elements and merchant, manufacturer or product, category or identity elements. The elements contained in this patent are for example purposes only to illustrate the process.

Banks associate categories of products, merchants, and manufactures with a restrictions code. As shown in FIG. 15, in an optional embodiment a bank displays restriction codes 1510 associated with categories or identity of products, merchants, and manufactures 1500. There is the product, merchant, or manufacture identity or category 1500 and the associated restriction code 1510. The restriction code may be sent using current electronic financial transfer systems modified to send, receive, and interpret restriction codes. Alternatively, the restriction code may be sent using other forms of electronic transfer of data. Currently, many systems exist for the transfer of financial data such as an Automated Clearing House or wire transfer of funds. Those financial systems transfer the payor account number, amount, and the payee account number. Those financial systems can be reprogrammed to transfer a restriction code along with the other data. It would require the addition of the restriction database 4330, or 5330 by the banking institutions 4200, 4300, 4400, 4500, 5200, 5300, 5400, or 5500 and the reprogramming of the software for the electronic financial transfer systems to implement this invention.

Each different type of restriction is associated with a code. For example suppose that the payor transferred funds to a payee as described in section A and H and desired that the funds only be used to purchase from selected merchants A, B, and C. Merchants A, B, and C are assigned merchant codes. Merchant A is assigned code 901; Merchant B is assigned code 902; and Merchant C is assigned code 903. Further, the restriction that the funds can only be used at the specified merchants can be in a separate code or part of the same code. If the restriction is a separate code then the merchant can send an action element or the letter “a” indicating approved for only what follows and follow with separate codes 901, 902, and 903.

Alternatively, the code can be a single code such as a901902903. The codes are assigned certain length intervals that the bank uses to identify them in this instance the interval length is three but in practice it will be much larger. Upon receiving this code a banking institution reads the first part of the code “a” for approved and the separate intervals of three 001, 002, and 003 indicating that the only approved merchants are Merchant A, Merchant B, and Merchant C. When the payor 4100, 5100 inputs the restrictions associated with the transfer of funds to the payor's bank 4200, 5200 and the identity of the payee's account 5370 or 4370, the payor's bank 4200, 5200 sends the restriction code to the payee's bank 4300, 5300. The payee's bank 4300, 5300 receives the restriction code and associates the funds with the restriction. The payee's bank 4300, 5300 understands the restrictions by accessing a restrictions database 4330, 5330. The payee's bank 4300, 5300 then stores the restrictions in the restriction storage database 4360, 5360 connected to the payee's bank system.

When the payee 5600, 4600 desires to make a purchase or withdraw funds, the merchant 4700 must send the merchant code to the bank. The merchant determines the code by accessing a product and merchant category code database 4720 connected to the merchant's system 4700, 5700. The payee's bank 4300, 5300 accesses the restriction storage database 4360, 5360 to determine if the code is approved to access the restricted funds. If the merchant code is approved then the payee's bank 4300, 5300 transfers the funds to the merchant account 4480, 5480 and completes the purchase. If the code is not approved then the payee's bank does not transfer the funds. For example the merchant sends merchant code 901 to the bank and the bank compares code 901 with the restrictions which indicate that 901 is approved. The bank then approves the transaction.

Suppose that the payor desired to specify a certain category of merchant such as merchants selling food. All banks 4200, 4300, 4400, 4500, 5200, 5300, 5400, or 5500 maintain a universal database of all merchants which sell food. A restriction code associated with food merchants could be 900. The payor's bank 4200, 5200 sends the following code to the payee's bank 4300, 5300: “a900”. This means that the payee's bank 4300, 5300 will only allow the restricted funds to be spent if the merchant code category falls within the 900 class or food merchants. The 900 class means all merchants identified with the first digit of 9, which range from 900 to 999. If the payor desire to prevent a certain merchant within this class, the following code is send “n” indicating “but not” followed by the code of the restricted merchant. For example the following code could be sent: “a900n903.” This means that all the food merchants in the 900 class would be approved except 903 or Merchant C. The payee's bank 4300, 5300 accesses the restrictions database 4330, 5300 to determine understand the restriction code.

Alternatively, payee's bank 4300, 5300 maintains the list of all merchants which sells food and has its list of approved merchants. If the payee's bank 4300, 5300 does not have a universal list then the payor's bank 4200, 5200 will send the merchant codes such as a901902903 to indicate which merchant are approved. Assuming each merchant is assigned a universal code, the payee's bank 4300, 5300 should be able to determine the approved merchant identity.

If the payor desired to restrict the funds to a certain category of item or service, the banks 4200, 4300, 4400, 4500, 5200, 5300, 5400, or 5500 maintain a universal database of item or service category codes. For example suppose the payor desired to restrict funds only the purchase of books for law. The category code could be assigned “400” for books generally and “410” for all books for law. To simplify the process and avoid confusion between item and service categories and merchant categories, the following variable code term can be used “p” indicating product. When the payor 4100, 5100 inputs the restrictions associated with the transfer of funds to the payor bank 4200, 5200 and the identity of the payee's bank 4300, 5300, the payor's bank 4200, 5200 sends the restriction code “ap410” to the payee's bank 4300, 5300, or only approved for product 410 or law books. The payee's bank 4300, 5300 receives the restriction code and associates the funds with the restriction. The payee's bank 4300, 5300 understands the restrictions by accessing a restrictions database 4330, 5330. The payee's bank 4300, 5300 then stores the restrictions in the restriction storage database 4360, 5360 connected to the payee's bank system. When the merchant 4700, 5700 requests payment from the payee's bank 4300, 5300 the merchant sends the code p410 to the payee's bank. The payee's bank 4300, 5300 then compares the restrictions which indicate only code p410 with the code the merchant sent or p410 to determine if the transaction is approved. The payee's bank 4300, 5300 approves the transaction and transfers funds to the merchant account 4480, 5480.

Alternatively, banks maintain individual categories codes. The payor's bank 4200, 5200 sends the payee's bank 4300, 5300 a written description of what the payor desires restricted such as only law books or “abooklaw.” The payee's bank 4300, 5300 receives this description and uses software to associate the description with a category code such as “ap410.” The payee's bank 4300, 5300 then stores the restrictions with the funds with the payee's bank 4300, 5300 specific category code, which the payee's bank receives by accessing the restrictions database 4330, 5330.

When the payee 4600, 5600 desires to make a purchase or withdraw funds, the merchant 4700, 5700 must send the item or service code to the bank. If the item or service does not have a code then the merchant 4700, 5700 sends the payee's bank 4300, 5300 the item or service description. The payee's bank 4300, 5300 uses software to associate item or service descriptions with category code by accessing the restrictions database 4330, 5330. The bank accesses the restriction database to determine if the code is approved. If the category code is approved then the bank transfers the funds and completes the purchase. If the code is not approved then the funds are not transferred.

If the payor 4100, 5100 desires to restrict the purchase to a specific category by a specific merchant, the following action element the letter, “o” is used indicating “only.” For example suppose the payor 4100, 5100 wanted to restrict the sale of law books to merchant D with a code 009. The following code would be sent: “ap410o009.” This indicates that the sale of law books is approved “ap410” to only merchant d, “o009.” If the payor 4100, 5100 desires to limit the category to all merchants except a certain merchant the code “n” is used indicating “but not.” For example, suppose the payor 4100, 5100 didn't like merchant d and didn't want to do business with merchant d. The following code would be used. “ap410n009.” This means that all merchants selling law books would be approved “ap410,” but not merchant D or “n009”

K. Account Creation Process

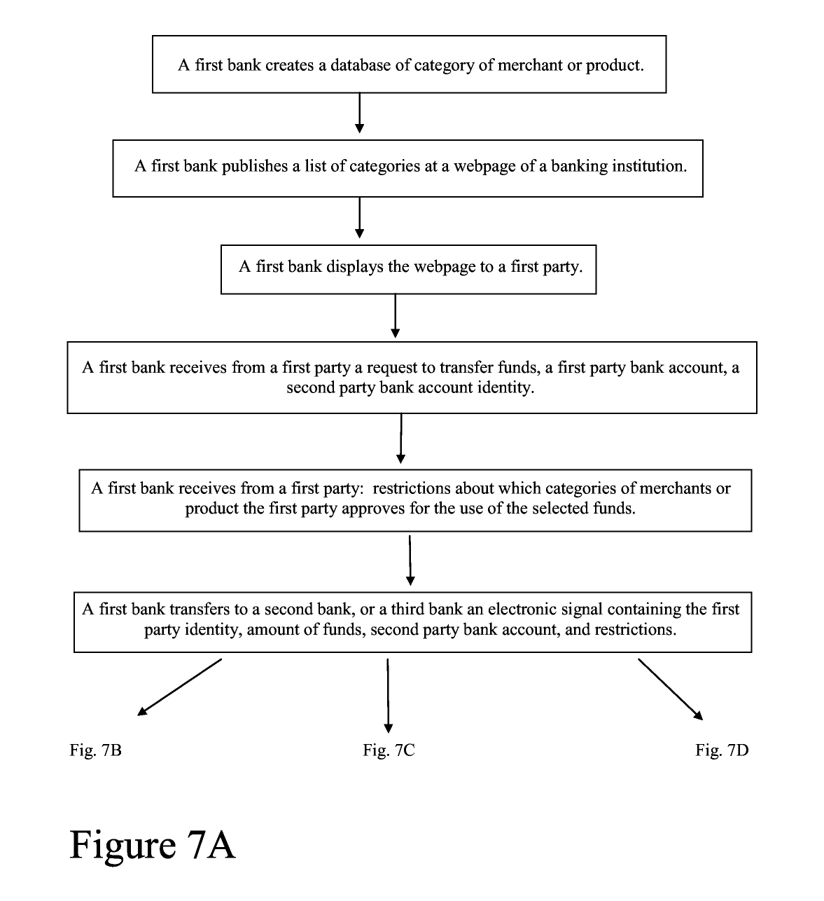

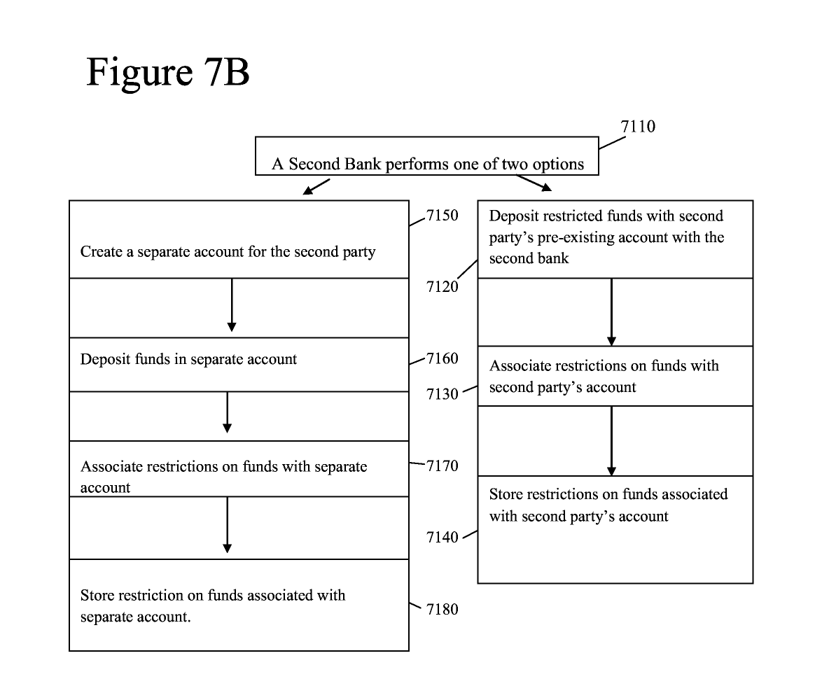

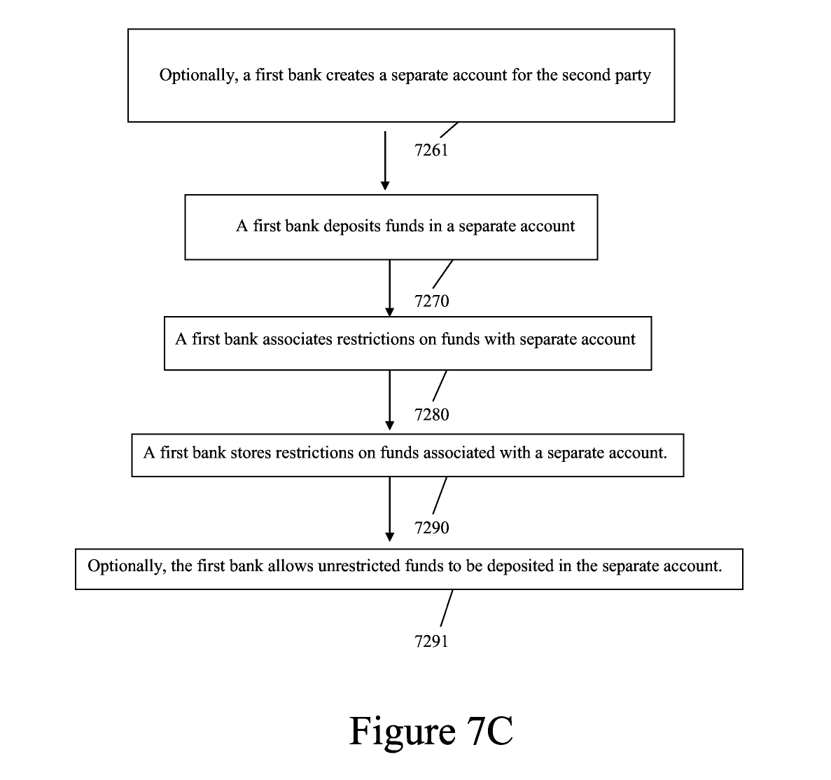

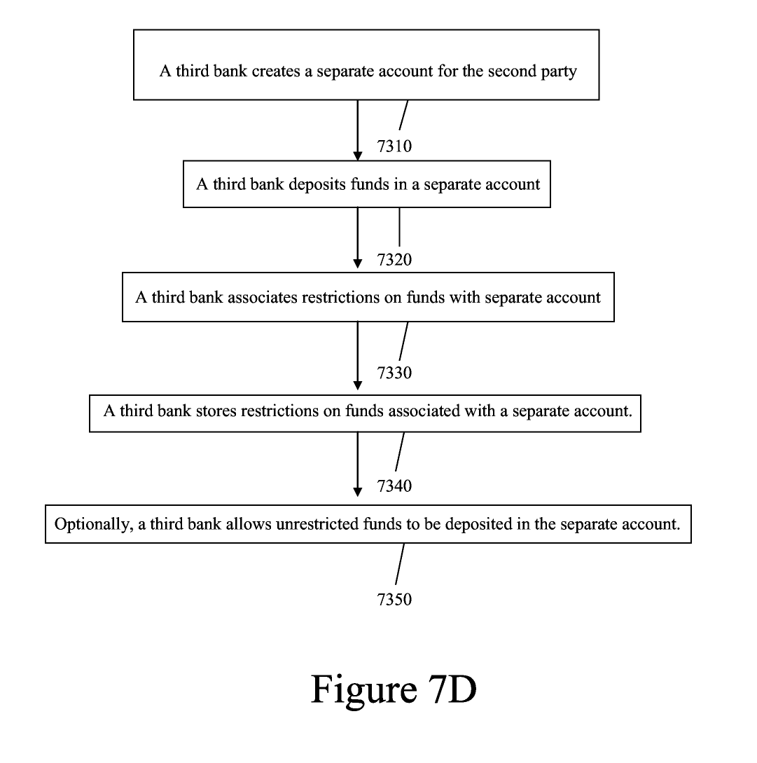

FIGS. 7A-D show a restricted transfer funds process from a first bank, second bank, and third bank. A first bank 7200 creates a database of categories of merchant and/or products 7210. A first bank publishes a list of categories at a webpage of a banking institution 7220. A first bank displays the webpage to a first party by sending the webpage information to the browser of the first party 7230. A first bank receives from a first party a request to transfer funds, a first party bank account, and a second party bank account identity 7240. A first bank receives from a first party: restrictions about which categories of merchants or product the first party approves for the use of the selected funds 7250. A first bank transfers to a second bank, or a third bank an electronic signal containing the first party identity, amount of funds, second party bank account, and restrictions. Optionally, a first bank doesn't transfer any funds or data electing to create an account at the first bank 7260. One of the first bank, a second bank, or a third bank performs functions next.

If the first bank transfers an electronic signal containing the first party identity, amount of funds, second party bank account, and restrictions to a second bank, the second bank performs one of two options 7110.

Option 1: a second bank 7100 creates a separate account for the second party with the second bank 7150. The second bank 7100 then deposits the restricted funds into the separate account 7160. Next, the second bank 7100 associates restrictions with the funds in the separate account 7170. The separate account itself is not restricted; the funds in the second account that have been transferred with restrictions are restricted. This means that unrestricted funds can be added and withdrawn from the account in addition to the restricted funds or that only a portion of the funds in the account are restricted. In this step, the account that contains funds with restrictions is identified and the restrictions on the funds in the account are associated with the account. Finally, the second bank 7100 stores the restrictions associated with the funds in a restriction storage database 7180.

Option 2: a second bank 7100 deposits restricted funds with second party's pre-existing account with second bank 7120. A second bank 7100 associates restrictions on funds with the second party's bank account 7130. The separate account itself is not restricted; the funds in the second account that have been transferred with restrictions are restricted. This means that unrestricted funds can be added and withdrawn from the account in addition to the restricted funds or that only a portion of the funds in the account are restricted. In this step, the account that contains funds with restrictions is identified and the restrictions on the funds in the account are associated with the account. Finally, the second bank 7100 stores the restrictions associated with the funds in a restriction storage database 7140.

If the first bank 7200 transfers an electronic signal containing the first party identity, amount of funds, second party bank account, and restrictions to a third bank 7300, the third bank performs the following actions. A third bank 7300 creates a separate account for the second party 7310. A third bank deposits funds in a separate account for the second party 7320. A third bank associates restrictions on the funds with a separate account 7330. The separate account itself is not restricted; the funds in the second account that have been transferred with restrictions are restricted. This means that unrestricted funds can be added and withdrawn from the account in addition to the restricted funds or that only a portion of the funds in the account are restricted. In this step, the account that contains funds with restrictions is identified and the restrictions on the funds in the account are associated with the account. A third bank stores restriction on funds associated with separate account in a restriction database 7340. Optionally, the third bank allows unrestricted funds to be deposited in the separate account 7350.

If a first bank 7200 doesn't transfer any funds or data to a second bank or a third bank and elects to create an account for the second party at the first bank, the following transpires. A first bank creates a separate account for the second party 7261. A first bank deposits funds in a separate account for the second party 7270. A first bank associates restrictions on the funds with a separate account 7280. The separate account itself is not restricted; the funds in the second account that have been transferred with restrictions are restricted. This means that unrestricted funds can be added and withdrawn from the account in addition to the restricted funds or that only a portion of the funds in the account are restricted. In this step, the account that contains funds with restrictions is identified and the restrictions on the funds in the account are associated with the account. A first bank stores restriction on funds associated with separate account in a restriction database 7290. Optionally, the first bank 7200 allows unrestricted funds to be deposited in the separate account 7291.

L. Payment Process by a Second Bank

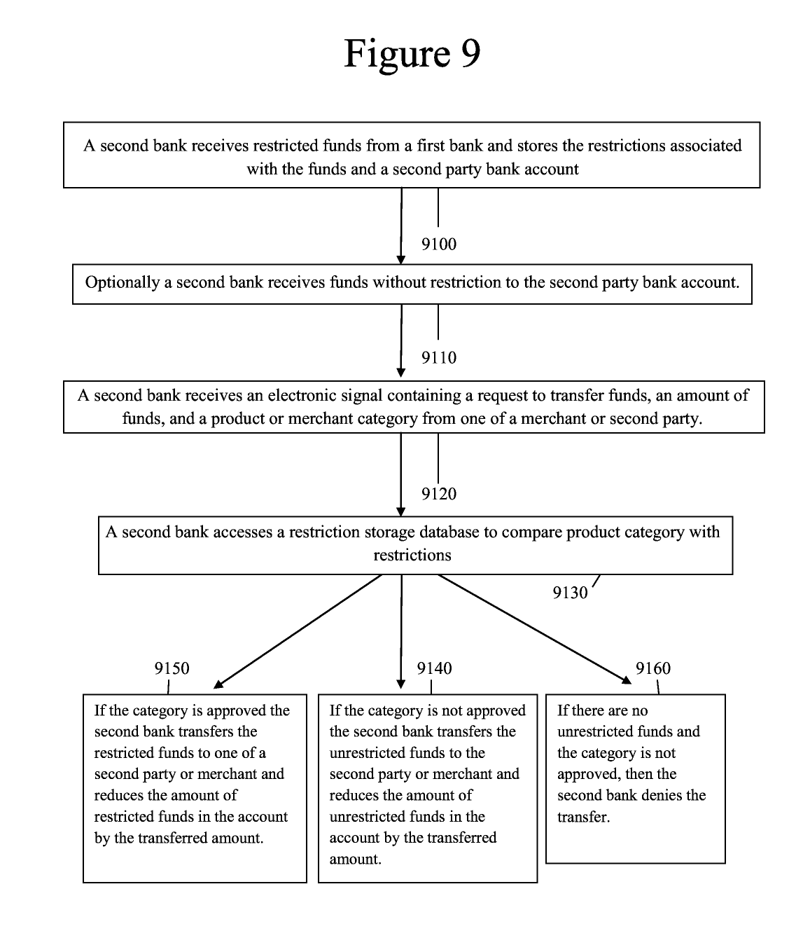

In FIG. 9, the following payment process by a second bank 7100 is described. A second bank is a bank which has funds transferred to it by a first bank on behalf of a second party as discussed in FIG. 7. A second bank receives an electronic transfer of restricted funds from a first bank and stores the restrictions associated with the funds 9100. Optionally a second bank receives funds without restriction to the second party bank account 9110. A second bank receives an electronic signal containing a request to transfer funds, an amount of funds, and a product or merchant category from one of a second party, or a merchant 9120. A second bank accesses a restriction storage database to compare product or merchant category with restrictions 9130. Next a second bank performs one of three options.

First, if the category is approved the second bank transfers the restricted funds to one of a second party, or merchant, and reduces the amount of restricted funds in the account by the transferred amount. 9150

Second, if the category is not approved then the second transfers the unrestricted funds to the second party or merchant and reduces the amount of unrestricted funds in the account by the transferred amount 9140.

Third, if there are insufficient unrestricted funds, then the second bank denies the transfer 9160.

M. Payment Process for a Third Bank

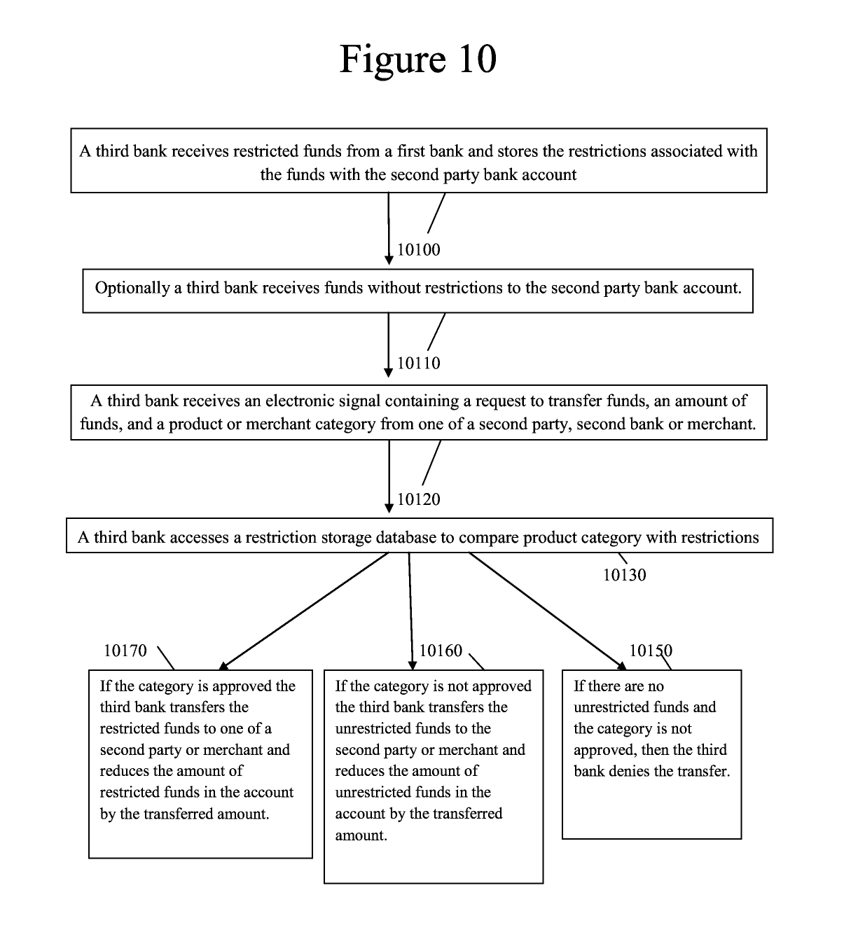

In FIG. 10, the following payment process by a third bank 7300 is described. A third bank is a bank which has funds transferred to it by a first bank on behalf of a second party as discussed in FIG. 7. A third bank receives an electronic transfer of restricted funds from a first bank and stores the restrictions associated with the funds 10100. Optionally a third bank receives funds without restriction to the second party bank account 10110. A third bank receives an electronic signal containing a request to transfer funds, an amount of funds, and a product or merchant category from one of a second party, second bank, or a merchant 10120. A third bank accesses a restriction storage database to compare product or merchant category with restrictions 10130. Optionally, the third bank receives a restriction approval code from the second bank 10140. Next a third bank performs one of three options.

First, if the category is approved the third bank transfers the restricted funds to one of the a second bank, second party, or merchant, and reduces the amount of restricted funds in the account by the transferred amount 10170.

Second, if the category is not approved then the third bank transfers the unrestricted funds to one of the second bank, second party, or merchant and reduces the amount of unrestricted funds in the account by the transferred amount 10160.

Third, if there are insufficient unrestricted funds, then the third bank denies the transfer 10160.

N. Payment Process for First Bank

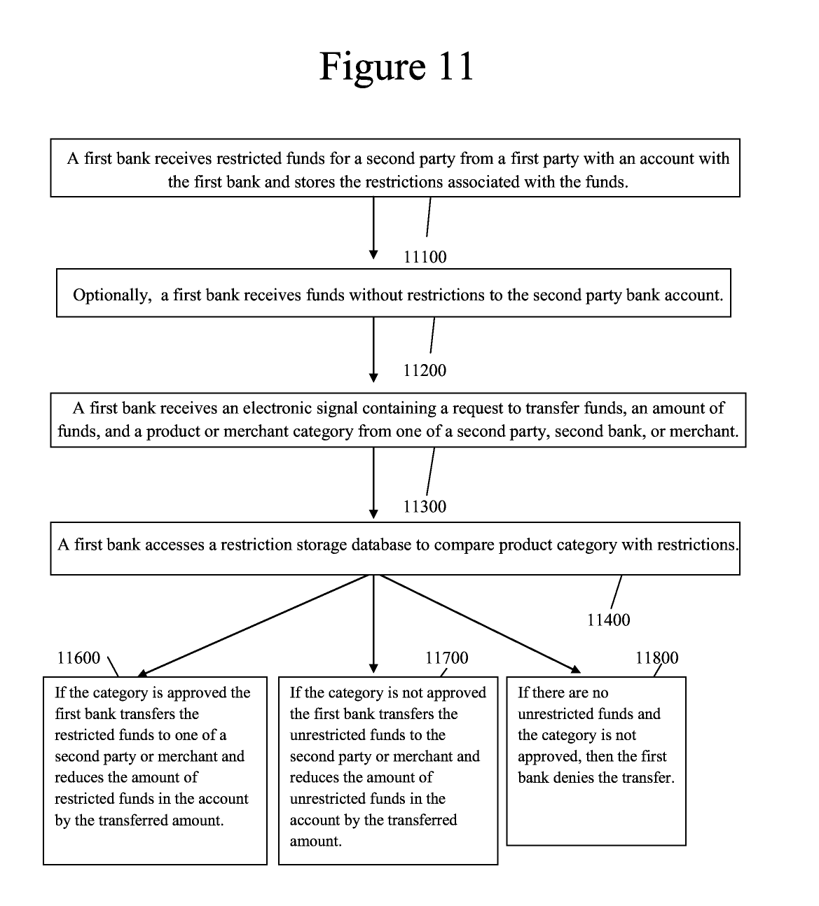

In FIG. 11, a payment process by a first bank 7200 is described. A first bank is a bank which belonging to the first party which initiates a transfer of restricted funds to a second party as discussed in FIG. 7. A first bank receives restricted funds for a second party from a first party with an account with the first bank and stores the restrictions associated with the funds 11100. Optionally a first bank receives funds without restriction to the second party bank account 11200.

A first bank receives an electronic signal containing a request to transfer funds, an amount of funds, and a product or merchant category from one of a second party, second bank, or a merchant 11300. A first bank accesses a restriction storage database to compare product or merchant category with restrictions 11400. Optionally, the first bank receives a restriction approval code from the second bank 11500. Next a first bank performs one of three options.

First, if the category is approved the first bank transfers the restricted funds to one of the a second bank, second party, or merchant, and reduces the amount of restricted funds in the account by the transferred amount 11600.

Second, if the category is not approved then the first bank transfers the unrestricted funds to one of the second bank, second party, or merchant and reduces the amount of unrestricted funds in the account by the transferred amount 11700.

Third, if there are insufficient unrestricted funds, then the first bank denies the transfer 11800.

O. Computer Architecture

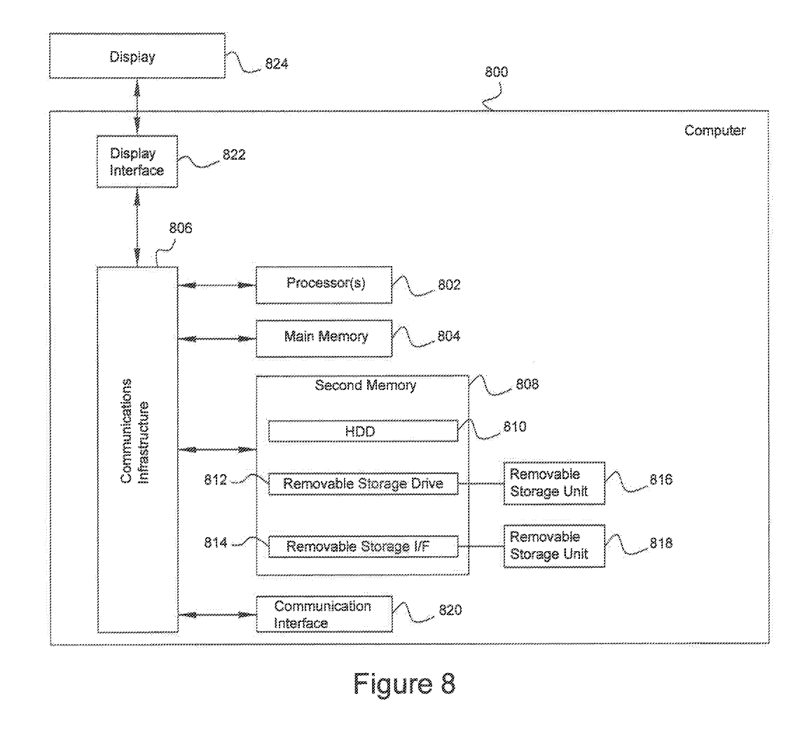

FIG. 8 illustrates one example of an architecture of a computer system 800 in accordance with some embodiments. Computer system 800 may be illustrative of computers for the payor 4100 or the payee 4600, or computers at the payor's bank 4200, payee's bank 4300, a third bank 4400, a central intermediary bank 5500 or a merchant 5700, or similar computers in FIG. 1 or 2. As illustrated in FIG. 8, computer system 800 may include one or more processors 802. Each processor 802 is connected to a communication infrastructure 806 (e.g., a communications bus, cross-over bar, or network). Computer system 800 may include a display interface 822 that forwards graphics, text, and other data from the communication infrastructure 806 (or from a frame buffer not shown) for display on the display unit 824.

Computer system 800 may also include a main memory 804, such as a random access memory (RAM), and a secondary memory 808. The secondary memory 808 may include, for example, a hard disk drive (HDD) 810 and/or removable storage drive 812, which may represent a floppy disk drive, a magnetic tape drive, an optical disk drive, a memory stick, or the like as is known in the art. The removable storage drive 812 reads from and/or writes to a removable storage unit 816. Removable storage unit 816 may be a floppy disk, magnetic tape, optical disk, or the like. As will be understood, the removable storage unit 816 may include a computer readable storage medium having tangibly stored therein (embodied thereon) data and/or computer software instructions, e.g., for causing the processor(s) to perform the operations of the above-described computer-implemented methods for electronic referral.

In alternative embodiments, secondary memory 808 may include other similar devices for allowing computer programs or other instructions to be loaded into computer system 800. Secondary memory 808 may include a removable storage unit 818 (which may be similar to removable storage unit 816) and a corresponding interface 814, which may be similar to removable storage drive 812. Examples of such removable storage units include, but are not limited to, USB or flash drives, which allow software and data to be transferred from the removable storage unit 818 to computer system 800.

Computer system 800 may also include a communications interface 820. Communications interface 820 allows software and data to be transferred between computer system 800 and external devices such as a server. Examples of communications interface 820 may include a modem, Ethernet card, wireless network card, a Personal Computer Memory Card International Association (PCMCIA) slot and card, or the like. Further, communications interface may be connected to an Automated Clearing House or other method of securely transferring financial data electronically. Software and data transferred via communications interface 820 may be in the form of signals, which may be electronic, electromagnetic, optical, or the like that are capable of being received by communications interface 820. These signals may be provided to communications interface 820 via a communications path (e.g., channel), which may be implemented using wire, cable, fiber optics, a telephone line, a cellular link, a radio frequency (RF) link and other communication channels.

In this document, the terms “computer program medium” and “computer readable storage medium” refer to media such as media at removable storage drive 812, or a hard disk installed in hard disk drive 810, or removable storage unit 816. These computer program products provide software to computer system 800. Computer programs (also referred to as computer control logic) may be stored in main memory 804 and/or secondary memory 808. Computer programs may also be received via communications interface 820. Such computer programs, when executed by a processor, enable the computer system 800 to perform the features of the methods discussed herein. For example, main memory 804, secondary memory 808, or removable storage units 816 or 818 may be encoded with computer program code (instructions) for performing the above-described computer-implemented methods for electronic referral.

In an embodiment implemented using software, software instructions may be stored in a computer program product and loaded into computer system 800 using removable storage drive 812, hard drive 810, or communications interface 820, for example. In other words, the computer program product, which may be a computer readable storage medium, may have instructions tangibly embodied thereon. The software instructions, when executed by a processor 802, cause the processor 802 to perform the functions of (operations of) methods described herein. In another embodiment, the method may be implemented primarily in hardware using, for example, hardware components such as a digital signal processor comprising application specific integrated circuits (ASICs). In yet another embodiment, the method is implemented using a combination of both hardware and software.

While examples of various embodiments have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A computer implemented method of the electronic restricting of funds preformed at a computer system of a first bank comprising:
creating a database containing categories and identities of merchants and products;
publishing a first list of categories and identities of merchants and products at a webpage of the first bank;
receiving from a first party a request to transfer funds, the amount of funds, a first bank account identity, and a second bank account identity;
receiving from a first party restrictions containing at least one of a category of merchant, category of product, identity of merchant, identity of a product from the first list the first party approves for the use of the selected funds.

2. A method of claim 1 further comprising:
receiving from a first party the identity of the second bank;
transferring to a second bank an electronic signal containing at least one of the first party identity, amount of funds, second bank account, and restrictions;
transferring first funds to the second bank account.

3. A method of claim 1 further comprising:
transferring to a second bank account at the first bank first funds from the first bank account;
storing the restrictions associated with the first funds on a database connected to the first bank system.

4. A method of claim 3 further comprising:
receiving funds without restriction to the second bank account with the first bank;
receiving an electronic signal containing a request to transfer funds, an amount of funds, and at least one of a category of merchant, category of product, identity of merchant, identity of a product, and second bank account identity;
accessing a restriction storage database to compare at least one of a category of merchant, category of product, identity of merchant, identity of a product with first party restrictions.

5. A method of claim 4 further comprising:
transferring the restricted funds;
reducing the amount of restricted funds in the account by the transferred amount.

6. A method of claim 4 further comprising:
transferring the unrestricted funds; and
reducing the amount of unrestricted funds in the account by the transferred amount.

7. A computer implemented method of the electronic restriction of funds preformed at a computer system of a third bank comprising:
creating a database of categories and identities of merchants and products;
publishing a first list containing categories of merchants, categories of products, identities of merchants, and identities of products at a webpage of the third bank;
receiving from one of a first bank and first bank user an electronic message containing a transfer request of restricted funds from a first bank account to a second bank account, the first bank account identity, amount of restricted funds, second bank account;
receiving from one of a first party and first bank restrictions about which of at least one of a category of merchant, category of product, identity of merchant, identity of a product, the first party approves for the use of the selected funds from the first list;
sending to the first bank account with a first bank a request to transfer funds to a second bank account, the amount of the funds, the restrictions associated with the funds, and the second bank account.

8. The method of claim 7 wherein the second bank account is located at a second bank.

9. The method of claim 7 wherein the second bank account is located at the third bank.

10. The method of claim 7 where in the second bank account is located at the first bank.

11. A method of claim 9 further comprising:
receiving funds without restriction to the second bank account with the third bank;
receiving an electronic signal containing a request to transfer funds, an amount of funds, and at least one of a category of merchant, category of product, identity of merchant, identity of a product from one of a second party, first bank, second bank, and a merchant;
accessing a restriction storage database to compare at least one of a category of merchant, category of product, identity of merchant, identity of a product with restrictions.

12. A method of claim 11 further comprising:
transferring the restricted funds to one of the first bank, second bank, and merchant;
reducing the amount of restricted funds in the second bank account by the transferred amount.

13. A method of claim 11 further comprising:
transferring the unrestricted funds to one of a the first bank, second bank, and merchant; and
reducing the amount of unrestricted funds in the second bank account by the transferred amount.

14. A computer implemented method of the electronic restriction of funds preformed at a computer system of a bank comprising:
receiving from one of a first bank user, a first bank, a second bank, and a third bank an electronic signal containing the first bank account identity, amount of restricted funds, second bank account identity, and restrictions;
storing the restrictions associated with the funds on a database connected to the bank's system;
adding the restricted funds into the second bank account;
associating the amount of funds added to the second bank account with restrictions received from one of a first bank user, a first bank, a second bank, and a third bank.

15. A method of claim 14 further comprising:
receiving funds without restriction to the second bank account;
receiving a request to transfer restricted funds from a second bank account, and at least one of a third party, a category of merchant, category of product, identity of merchant, identity of a product, from one of a merchant and a third party;
accessing a restriction storage database to determine the restrictions associated with the funds;
comparing the restrictions associated with the funds with at least one of the third party, category of merchant, category of product, identity of merchant, identity of a product.

16. A method of claim 15 further comprising:
transferring the restricted funds;
reducing the amount of restricted funds in the account by the transferred amount.

17. A method of claim 15 further comprising:
transferring the unrestricted funds; and
reducing the amount of unrestricted funds in the account by the transferred amount.

18. A method of claim 14 wherein the bank contains both the first bank account and second bank account.

19. A method of claim 14 wherein the bank contains the second bank account but not the first bank account.

20. A method of claim 14 wherein the restrictions are received via check.
